(19) United States
(12) Patent Application Publication
(10) Pub. No.: US 2024/0299140 A1
(43) Pub. Date: Sep. 12, 2024

(54) Flexible Implant Abutment and Process

(71) Applicant: Eric Jon Knutson, Granite Bay, CA (US)

(72) Inventor: Eric Jon Knutson, Granite Bay, CA (US)

(21) Appl. No.: 18/182,141

(22) Filed: Mar. 10, 2023

(51) Int. Cl. A61C 8/00; A61C 13/00

(52) U.S. Cl. CPC A61C 8/005; A61C 13/0003

(57) ABSTRACT

A flexible abutment for securing to an implant, where the implant is implanted into an osseous structure. Ambient forces impinging on the flexible abutment tend to substantially deform, and be absorbed by, the flexible abutment. As such, ambient forces subsequently transferred from the flexible abutment to the implant, and thence to the osseous structure, are substantially reduced, thereby reducing the chances of osseointegration failure. A method for implanting an implant having a flexible abutment is also provided.

### FIELD OF INVENTION

The invention relates to dental implant healing abutments, and to prostheses secured to implants. Dental implants have a platform configured for making connections to the implant. Healing abutments and prostheses are secured to platforms in order to occupy the space thereover during and after osseointegration of the implant.

Healing abutments occupy the space over the platform in order to control gingival healing after implant placement. Controlling gingival healing includes controlling gingival contours, such as for creating a desirable emergence profile. Controlling gingival healing also includes the reduction of bacteria and debris around the implant site.

Healing abutments are generally secured to the implant after implant placement. At the discretion of the clinician, a healing abutment may be secured to the implant immediately after the implant placement initial surgery, prior to osseointegration. The implant placement initial surgery that is performed prior to osseointegration is called a first stage surgery.

Alternatively, a healing abutment may be secured to the implant after a later surgery for exposing the implant from the healed gingiva that covers the implant after substantial osseointegration has occurred. The implant exposure surgery after a given degree of osseointegration is called a second stage surgery.

When implants have moderate to low initial stability at the stage one surgery, then clinicians often place a cover screw that protrudes only slightly above the implant platform. The cover screw permits closure of the gingival incision, so that the gingiva can heal to cover the healing abutment or cover screw. As such, the gingiva protects moderate or low stability implants from unwanted ambient forces during healing.

Alternatively, if a standard healing abutment were placed, forces impinging on the healing abutment would be transferred directly to the implant. Such transferred forces increase the risk of osseointegration failure. However, even with higher stability implant placements, ambient forces can increase the risk of implant failure.

Temporary or permanent tooth-shaped prostheses are also secured to implants before and after a given degree of osseointegration. Prostheses are typically placed when implant stability within the osseous structure is high, and chances of osseointegration failure are manageable.

### BACKGROUND

Healing abutments are securely connected to dental implants while the implant osseointegrates, and while the gingiva heals. Healing abutments are designed to optimize gingival healing.

Healing abutments of the art are made for various functions. Some healing abutments are made in an assortment of stock or custom shapes designed to more precisely influence gingival contours. Some healing abutments mimic the appearance of teeth. Some healing abutments are configured to engage impression copings and scan bodies without requiring removal of the healing abutment. Some healing abutments are made to function as markers for CT imaging. Some healing abutments are configured to support a dental prosthesis, having the ability to function as a prosthetic abutment. Some healing abutments are configured to have the appearance of a dental prosthesis, eliminating the need for a separate prosthesis.

Healing abutments of the art are made to inhibit bacteria and debris around the healing implant. Some healing abutments are made to limit spaces accessible to bacteria, such as by securely seating with Morse taper configuration. Some healing abutments have surface materials, configurations, textures, and so on, to inhibit bacteria.

Healing abutments are manufactured by casting, printing, milling, shaping by use of handheld rotary instruments, or other methods known in the art, using substantially rigid materials. Materials used included titanium, stainless steel, zirconium oxide, rigid plastics, and so on.

Unless a newly inserted implant has high insertion torque values, or high stability meter readings, healing abutments are not generally placed during the initial implant placement surgery, called the stage one surgery, or the first stage surgery.

When an implant has low to mid-level stability, generally a cover screw is connected to the implant platform to cover the implant platform, and the gingiva is closed to cover the implant and cover screw. This gingival closure is performed to isolate the non-osseointegrated implant from oral bacteria and debris. Gingival closure also allows the gingiva to absorb ambient forces that are randomly brought against the non-integrated implant region or area. When forces are brought against the gingival closure over the implant, the soft gingiva readily deforms and absorbs the forces. As such, forces transferred to the healing, non-integrated, implant are reduced relative to the forces that would otherwise be transferred if a rigid healing abutment were secured to the implant, and especially if protruding above the gingiva.

If gingiva was not covering the implant, cover screw, or rigid healing abutment, then ambient forces are more likely to directly impact the implant. Such forces are known in the art to interfere with osseointegration of the implant.

After an appropriate osseointegration healing period, and a degree of osseointegration has occurred, a stage two surgery is required to remove the gingival cover from over the implant, thereby uncovering the implant, and providing access to the cover screw in the implant platform.

Removal of the cover screw at the second stage surgery can be complicated by an undesirable overgrowth of bone that partly covers the cover screw. The overgrown bone has to be carefully cut away, which introduces a risk of damaging the implant platform. After any overgrown bone is removed, the cover screw may be successfully removed.

Some clinicians elect to place a taller cover screw that is still coverable by the gingiva after placement, but can reduce the likelihood of bony overgrowth. These tall cover screws can also have some benefit for pre-shaping the gingiva.

After removal of the cover screw, a healing abutment is placed for optimizing gingival healing. A healing abutment is selected that will protrude slightly above the external gingival surface, and will preserve and shape the gingival access hole to the implant. The gingiva is sutured around the healing abutment, and an additional gingival healing period is required prior to making a prosthesis, such as by taking impressions. An additional healing period is also utilized prior to placing a locator attachment, such as locators used with overdentures. The healing period permits the gingiva to heal to attain a degree of resistance to damage or displacement, as well as to assume a more stable shape after inflammation and edema is reduced.

The typical healing time period allowed following the stage two surgery only permits partial gingival healing, and does not permit complete healing. Clinicians and patients typically do not want to wait much more than two to three weeks to have the patient back for prosthetic impressions. More complete healing can take 6 weeks to 6 months. The shortened time periods typically selected reflect a compromise between an acceptable degree of healing and the desire to complete the prosthetic phase of treatment as soon as possible.

When placing a rigid healing abutment, sometimes the bony margins around the opening of the implant osteotomy will interferingly contact an external wall of the healing abutment prior to the healing abutment being seating fully into the implant. Such interfering contact between the osteotomy and the healing abutment, called a bony interference, can prevent the healing abutment from seating fully and securely into the implant platform.

When a bony interference is encountered during an attempted seating of a healing abutment into an implant platform, the bony interference creates a resistance to rotation, or increase in torque, of the healing abutment that mimics the resistance of proper seating into the platform. As such, clinicians are often unaware that a bony interference is occurring. When a bony interference occurs, clinicians can mistakenly discontinue further rotation of the healing abutment before the healing abutment is secured to the implant. When this occurs, the bony interference has prevented the healing abutment from being secured into the implant, and the healing abutment remains unsecured.

While the bony interference issue can be prevented by employing the additional step of bone profiling, it is a common occurrence for clinicians to be unaware of a bony interference.

Unsecured healing abutments often prematurely loosen or fall out of the of the implant and gingival access hole. This creates a risk of swallowing or aspirating the healing abutment. Premature healing abutment loosening can require an extra office visit with anesthesia, gingivectomy, bone profiling, and reseating of the healing abutment, followed by additional healing time.

In order to reduce the possibility of premature loosening, healing abutments are manufactured from rigid materials. Healing abutments comprised of rigid materials have a greater chance of remaining secured to an implant than less rigid materials would be. In addition, manufacturing of these relatively small parts is simplified by forming them of rigid materials, and especially monolithic materials.

When implants have sufficiently high stability at initial placement, the stage one surgery, many clinicians prefer to connect a healing abutment to cover over the implant platform rather than place a cover screw. The healing abutment typically protrudes slightly above the level of the gingival external surface. When a healing abutment protrudes above the gingiva, then the healing abutment placement is considered to be transmucosal.

As the gingiva heals against the protruding healing abutment, it assumes a desirable shape largely determined by the healing abutment contours. Inadvertent and undesirable forces randomly impinging on an exposed healing abutment are less likely to cause osseointegration failure when there is high initial implant stability. However, there still remains some risk of sufficiently strong forces disrupting osseointegration.

For the purposes of the present invention, healing abutments can be considered to have a body portion for managing gingival healing, and a connector portion for securing the body to the implant platform. The body has a volumetric shape, the surface of which is configured to influence gingival healing. The connector is generally a rigid, threaded screw-like protrusion for securely mating into the implant platform.

When a hard prosthesis is secured to an implant, ambient forces born thereby are substantially transferred to the osseous structures. Such forces are known to disrupt ongoing and completed osseointegration, and are known to cause implant failure. As a result, prostheses are only secured to implants when the implant stability is deemed to be high.

In the art, elastomeric materials of the art are configured as a thin covering over rigid implant structures. Due to the minimal thickness of the elastomer, the distance of the deflection of the elastomeric covering when under load from ambient forces would be insignificant for the purpose of insulating the implant from such forces. Deflections of less than 0.5 mm would be expected, and more likely would be less than 0.3 mm. As such, substantial forces are transferable through the thin elastomeric abutment covering to the rigid abutment, and thence to the implant and the osseous structures.

In the art, elastomeric materials have been configured as a thin intermediary between the implant platform and a rigid abutment, where the abutment generally comprises a permanent prosthesis. The elastomers have been semi-rigid, high durometer elastomers provided that permit slight movements of the abutment that would mimic natural periodontal ligament (PDL) compressions that permit natural teeth to deflect up to 0.25 mm in the tooth socket.

Ambient forces against thin or semi-rigid elastomeric materials on such implant abutments are substantially transferable to the implant. Such substantial force transfer increases risks of osseointegration failure.

Current research is investigating potential attachment of periodontal ligament fibers to receptive dental implant surfaces. As such, custom-shaped implants could be implantable into tooth sockets where healing would comprise waiting for periodontal ligament fibers to attach to the implant. This technology would be especially useful when teeth fracture over a healthy intact alveolus. Ambient forces transferred to an implant awaiting fiber reattachment could increase the failure rates of such implants. For the purposes of the current invention, terms referring to osseointegration of implants are interchangeable with terms for periodontal ligament healing, and are not to be construed as limitative.

The platform of an implant is defined here to include all surfaces and structures located within the outside diameter at the top of the implant, including tapered portions, anti-rotational portions having flanks and corners, screw holes, vertical surfaces, horizontal surfaces, and so on.

### SUMMARY

The present invention is directed to placing dental implants, and the use of healing abutments and prostheses for managing of gingival and osseous healing and maintenance.

For the purposes of this discussion, the term “abutment” is used broadly, and includes healing abutments for use during gingival and osseous healing, and also includes abutments that remain secured to an implant after gingival and osseous healing is substantially complete. In some implementations, the term abutment includes an implant temporary or final prosthesis.

The terms “facial” and “buccal” are used interchangeably and are not to be construed as limitative. The term “lingual” is intended to include the term “palatal.” The terms “over” and “under” are used as if the dental implant is placed vertically in an osteotomy with the platform facing upward, but the terms are not to be construed as limitative. The terms “soft”, “flexible”, and “elastomeric” are used interchangeably.

In the present invention, an abutment is substantially comprised of flexible or elastomeric materials, such that the abutment is substantially flexible. The flexible abutment is securable to an implant before or after implant insertion into an osseous structure.

In some implementations, flexible abutments are manufactured as stock components. In some implementations, the configuration of flexible abutments are geometrically symmetrical. In some implementations, the configuration of flexible abutments is generally anatomical, and even customized to the specific site of an individual patient. In some implementations, the configuration of stock components are modifiable by the clinician, such as by manual milling, CNC, material addition, and so on. In some implementations, flexible abutments of the present invention may be custom manufactured by processes including 3D printing, milling, or custom molding, and such processes may utilize data from 3D scanning, CT imaging, and so on. Suitable flexible materials include silicone, PEEK, rubber, and so on.

The healing abutment of the present invention has an elastomeric body portion, and may be considered to be a substantially soft, flexible abutment. The flexible abutment at least substantially occupies the space over the implant platform in order to contact the gingiva thereover, and to manage gingival healing after implant placement. The elastomeric material of the body has a sufficiently low durometer such that it readily deforms under a forceful load. When the body deforms and flexes under forceful loading, then the ambient forces impinging on the surface of the elastomeric body are substantially absorbed and diffused by the elastomeric body.

The body is therefore configured to be substantially flexible throughout at least the greater portion of the body volume. Body flexibility is greatest for the portion that is distal from the implant platform.

Further, the body of the flexible abutment lacks the presence of higher durometer, more rigid, materials or structures a small distance under the top surface of the body, where the top surface of the body is the portion that is distalmost from the implant platform, and generally protrudes above the gingiva. Instead, the flexible material comprising the body extends to a substantial depth below the top surface of the body.

The body portion distal from the platform is substantially flexible. Typically, the mid-body portion, located between the distal portion and the portion adjacent to the connector, is also substantially flexible. In some implementations, the body is uniformly substantially flexible throughout the entire volume of the body. In some implementations, the body portion adjacent to the connector is somewhat less flexible that the more distal portions.

Ambient forces brought to bear against the surface of the flexible body are substantially absorbed and diffused. As such, significantly less force is transferred to the implant or to the osteotomy via the soft, flexible, healing abutment.

When an implant has low to moderate stability at the stage one surgery, a flexible abutment may be selected that transmucosally protrudes slightly above the gingival surface, such that the gingiva does not cover the flexible abutment after healing. When a transmucosal flexible abutment is secured to the implant during the healing period, ambient forces impinging on the flexible abutment are absorbed by the elastomeric body. As such, significantly less force is transferred to the implant, or to the healing osteotomy, and the chances of successful osseointegration of the implant are increased. The distance that the flexible abutment protrudes above the gingiva is minimized to as to minimize the ambient forces impinging thereon.

When an implant has moderate to high-level stability at the stage one surgery, a flexible abutment may be selected that protrudes significantly further above the gingival surface, and may be configured to mimic the appearance of a natural tooth.

When a flexible abutment protrudes a significant distance above the gingival surface, the flexible abutment is thereby exposed to additional ambient forces in the oral environment. As such, the level of ambient forces absorbed by the flexible abutment are increased.

For given higher stability stage one surgeries, such an increase in ambient forces due to a protruding, tooth-shaped, flexible abutment may be deemed to insignificantly increase the chance of osseointegration failure.

Further, when a flexible abutment is seated into an implant where the osteotomy has a potentially interfering bony margin, the soft body can inadvertently contact the bony margin so that a bony interference occurs. When the bony interference occurs with the flexible abutment, then the bone will readily deform the flexible abutment.

Due to easy deformation of the lateral walls of the soft body during bony interferences, a significant premature increase in torque does not tend to occur such as encountered with hard healing abutments. As such, the clinician does not sense a premature resistance to rotation when attempting to tighten the flexible abutment. As such, the normal seating torque increase occurs only when the healing abutment is fully and properly seating into the implant. The clinician is thus able to properly secure the flexible abutment into the implant platform despite the presence of a bony interference contacting the flexible abutment.

In some implementations, the flexible abutment configuration is matched to an osteotomy configuration so that the flexible abutment intentionally interferes with the osteotomy margins or walls in order to seal out bacteria and debris, or to increase implant stability. For example, this may be preferred for some implant placements where the platform depth is greater than 1 mm from the osteotomy margins.

In some implementations, a flexible abutment is configured so as to intentionally interfere with distal portions of the platform in order to reduce interstitial spaces available to harbor bacteria and debris.

In some implementations, the durometer of portions of the body are selected so as to create a given level of pressure against the osteotomy margins to cause the osteotomy bone to pressure remodel and reshape to a desirable configuration. The desired configuration may facilitate proper seating of other devices into the implant, such as an impression coping, a scan body, a stability measurement peg, or a final prosthesis.

In some implementations, the body is provided in a moldable state, such as a material that is moldable until exposed to a curing light, or utilizes a two-part mix. After the flexible abutment is secured to the Implant, and the moldable Body is molded to a desirable shape, then the body is rendered substantially non-moldable. Once the body is rendered substantially non-moldable, however, it remains substantially flexible.

The connector portion of the flexible abutment secures the flexible body to the implant platform. In some implementations, the connector is comprised of a screw, and an anti-rotational male external hex portion for engaging into a female internal hex socket of the implant platform. As such, the external hex anti-rotationally keys into the internal hex socket of the implant platform when seated thereby assuring specific rotational alignments of the flexible abutment relative to the implant platform. The seated, keyed, external hex is securable by securing the screw into the implant platform screw hole.

In some implementations, the screw has an internal drive socket for engaging a drive tool, such as an internal hex socket. In some implementations, the screw is configured like other screws known in the art.

In some implementations, the connector is comprised of a screw and a rotatable male cylinder for engaging into a female internal socket of the implant platform, where at least the external surface of the connector has an elastomeric coating. As such, when the cylinder is seated into the female internal socket of the implant platform, the elastomeric connector coating deforms slightly to permit full and proper seating. The deformation of the connector surface significantly inhibits rotation of the cylinder relative to the female internal implant socket. Further, deformation seating of the connector may enhance sealing off interstitial spaces from bacteria and debris.

In some implementations, the greater volume of the connector portion is substantially flexible and elastomeric. Portions of such an elastomeric connector have sufficient rigidity to maintain secure connection to the implant platform and to the flexible abutment body. However, the entire volume of the connector may be substantially elastic, and still remain capable of maintaining connector to an implant platform, such as by engaging undercuts in the implant platform, by adhesion, or by other elastomeric connection means known in the art. In some implementations, the elastomeric body and the elastomeric connector are substantially monolithic.

In some implementations, the soft body of the flexible abutment is reattachably detachable from the cylinder, such that the body may be detached from the cylinder, and then reattached to the cylinder, as needed. Such detachable reattachment may be achieved by engaging undercuts, using adhesives, and so on.

It is an object of the present invention to configure the flexible abutment so that occlusal interferences are substantially eliminated.

In some implementations, the volume and shape of at least the supergingival portion of the soft body is made to replicate the shape of a tooth for cosmetic purposes, such as having a substantial resemblance to the tooth that typically occupies the site. In some implementations, such a soft tooth is uniformly comprised of soft material. In some implementations, the facial surface of the soft tooth is comprised of a firmer material that remains somewhat flexible due to minimal thickness, and the remaining bulk of material toward the lingual side is comprised of a softer material. In some implementations, the firmer facial layer extends to the connector area. In some implementations, the firmer facial layer comprises the same material as the connector. In some implementations, the soft tooth has an access hole through the soft body that permits a driver to engage a screw or other drive socket.

In some implementations, a flexible tooth facing comprises a thin, flexible facial wall having minimal thickness, wherein the tooth facing connects to the connector, and wherein a soft filler occupies a substantial portion that contacts the gingiva above the connector.

In some implementations, a flexible facing abutment comprises a thin facial wall having minimal thickness, wherein the facing abutment connects to the connector, and wherein the facing abutment includes a portion comprising a thin, flexible perimeter contacting a substantial portion of the gingiva above the connector, and comprising a central open area that surrounds a screw. The height of the thin perimeter is customizable by the clinician in order to minimize ambient forces transferable to the connector and platform.

In some implementations, a flexible shell tooth comprises a flexible wall configured in the shape of a tooth, the wall having minimal thickness, wherein the shell tooth connects to the connector. In some implementations, the flexible wall of the shell tooth has a degree of flexible rigidity, wherein the material would otherwise have significant rigidity at a sufficient dimensional thickness. However, at the provided thickness, the flexible wall is sufficiently thin so as to remain substantially flexible, and deform readily under load, and otherwise respond to forces similarly to a low durometer material. In some implementations, the flexible wall is comprised of a low durometer, soft material, that is readily deformable. In some implementations, the flexible wall is comprised of an elastic material that is readily stretchable. In some implementations, the configuration of a stretchable flexible wall is fabricated to resemble a tooth. In some implementations, the configuration of a stretchable flexible wall is fabricated to resemble a tooth only after sufficient inflation, such as with a gas, liquid, or particulate. In some implementations, the shell tooth has an access hole for a driver to engage a screw or other drive socket.

In some implementations, a shell abutment comprises a firm but flexible shell that surrounds the screw with a thin perimeter having a central open area, thereby contacting a substantial portion of the gingiva above the connector. The open central area provides screw access and is able to contain a soft filler. The clinician has the ability to customize the height of the thin perimeter in order to minimize ambient forces transferable to the connector and platform. In some implementations, the connector has an external hex for anti-rotationally keying into the internal hex of the platform. In some implementations, the connector has a smooth male cylinder for nesting into the internal hex of the platform that lacks anti-rotational function.

In some implementations, a flexible cap for managing gingival healing after implant placement comprises a homogenous elastomeric body provided in an assortment of sizes and shapes, such that it protrudes only a slight distance above the surrounding gingival surface. The distance that the soft cap protrudes above the gingiva is just sufficient such that the gingiva is unlikely to cover the flexible cap. The distance that the flexible cap protrudes above the gingiva is also minimized such that ambient forces brought to bear on the soft cap are minimized.

In some implementations, a connector of the flexible cap includes an external hex for anti-rotationally keying into the implant platform, and a screw. In some implementations, a connector of the flexible cap is monolithic, comprising a protruding male cylinder that is seatable into a female hex socket of an implant platform, such that the connector freely rotates inside the female hex socket, and comprising a threaded extension for securing into the implant screw hole.

In some implementations, the soft body is expandable or distendable with fluid or gas, and is called an expandable body. A flexible abutment having an expandable body can be considered to be an expandable healing cap. The expandable body has an external wall that resists leakage of fluids or gasses, especially during stretching and distension. The internal volume is capable of receiving and containing fluids or gasses. The internal volume may be comprised of a single hollow cell, or of multiple spongy cells, and so on. When fluid or gas is forcefully injected into the internal volume of the expandable body, the internal volume of the expandable body is pressurized. Such pressurization of the internal volume of the expandable body causes stretching and enlargement of an exterior wall of the expandable body. As such, the size and shape of the expandable body may be adjustable by adding or subtracting fluid or gas.

In some implementations, the expandable body is at least partly comprised of materials capable of slowly absorbing ambient fluids, such that the body will expand gradually over a period of weeks to months. As the expandable body absorbs fluids, and thereby expands, the surface of the expandable body applies pressure to the surrounding gingival covering, and eventually causes the gingival covering to thereby slough away. The expandable body is thus eventually exposed to the oral cavity. Absorbent materials of the art include hydrogels, cellulose, and so on.

In some implementations, the rate of fluid absorption by the absorptive material is controlled or delayed by various containment means, such as semipermeable membrane covers, dissolvable plugs in the exterior wall of the expandable body, and so on. In some implementations, containment means cover single absorbent particles. In some implementations, containment means cover multiple absorbent particles.

The external surface of the expandable body is configured to facilitate controlled enlargement of the expandable body, such that the enlargement causes the top surface of the expandable body to move away from the connector, and press forcefully against the gingival covering the expandable body. Further, the controlled enlargement facilitates achieving a desirable shape of the expanded body, such as a shape that would cause the surrounding gingiva to remodel in a desirable emergence profile.

Such controlled stretching is achieved by configuring the external surface of the expandable body. In some implementations, some portions of the eternal surface have relatively high flexibility, while other portions of the eternal surface have relatively lower flexibility. In some implementations, portions of the internal area of the body vary in flexibility.

In some implementations, the top surface of the expandable body is further configured to resist fluid leakage after puncture by a needle, similarly to the functionality of a medicine vial stopper.

In some implementations, the top surface of the expandable body has surface features that facilitate gingival sloughing, at least after pressurization of the expandable body. Such surface features can include somewhat sharp protrusions having a higher rigidity relative to the expandable body. In some implementations, such sharp protrusions do not protrude from the top surface prior to pressurization, but only after pressurization.

In some implementations, expansion causes the sharp protrusions to become deployed by unfolding, such that the angulation of the protrusions are rotated from a more parallel angle, with respect to the top surface, to a more perpendicular angle. In some implementations, the sharp protrusions are deployed by moving out from a retracted, nested, position, or by telescoping the protrusions, and so on. As such, surface features are able to provide focused and directed pressures against the gingiva, thereby facilitating gingival sloughing from over the expandable body.

In some implementations, an access hole is provided through the expandable body such that a drive tool is engageable with a screw or drive socket for securing or loosening the expandable healing abutment from an implant platform.

In some implementations, a flexible cap is entirely comprised of an elastomeric body and an elastomeric connector. In some implementations, the connector has an extension that engages the threads of the implant screw hole. In some implementations, the connector has tabs for engaging undercuts in the internal hex of the implant.

In some implementations, a soft abutment is manufactured to be substantially integrated to an implant so that the soft abutment is not readily detachable from the implant, such that the implant is combined with the soft abutment. In some implementations, such an implant-abutment combination is manufactured continuously so that the implant and the soft abutment are fabricated without significant pause in the manufacturing process. In some implementations, the soft abutment is manufactured after the implant manufacture has been completed.

For any of the implementations of a soft abutment, including soft prostheses, the driver access hole may have a reduced diameter in at least one dimension so as to reduce the accumulation of debris in the access hole, such as an access hole with a slit opening. In some implementations, the access hole is occludable with a soft cylindrical plug, or other means of reversibly occluding the access hole, for limiting debris accumulation.

In some implementations where the axis of the osteotomy and implant has significantly different angulation relative to a tooth shaped soft abutment, then the orifice of the access hole may be located lingually relative to the central axis of the implant to facilitate driver access to the drive socket. As such, the access hole and the incisal edge portion of the tooth-shaped abutment are able to flex to permit straight-line access to a drive socket.

In some implementations, the exposed surface of the body includes scanning features such that 3D scanning of the surface permits 3D locating of the implant for digital case planning, so that the body is considered a scannable body. A scannable body generally requires an anti-rotational connection to the platform.

In some implementations, flexible abutments are manufactured in various stock configurations. In some implementations, flexible abutments are custom manufactured from CT data combined with guided implant placement. As such, custom body shapes can form gingival emergence profiles that can mimic those of natural teeth, or create other desirable gingival shapes.

In accordance with another aspect, there is provided a method for securing a prosthesis to an implant comprising the steps of: inserting an implant into an osteotomy, securing a flexible abutment to the implant, waiting a time period for a degree of implant osseointegration to occur, making the prosthesis, removing the flexible abutment from the implant, and securing the prosthesis to the implant.

In some implementations, the flexible abutment remains uncovered by gingiva during the entire osseointegration time period.

In some implementations, the flexible abutment is secured to the implant, the flexible abutment is covered by gingiva, a time period for osseointegration elapses, the flexible abutment is expanded to an increased size sufficient to cause the gingiva to slough off of the flexible abutment, thereby uncovering the gingiva from flexible abutment so that the flexible abutment is exposed.

In some implementations, the flexible abutment remains secured to the implant while making prosthetic impressions. In some implementations, the flexible abutment is removed from the implant while scanning or making prosthetic impressions, and then resecured to the implant while the prosthesis is made.

In accordance with another aspect, there is provided a method for securing a soft prosthesis to an implant comprising the steps of: inserting an implant into a bony structure, securing a soft prosthesis to the implant, such that the soft prosthesis is elastomerically deformed by forces impinging thereupon, thereby reducing forces transferred to the implant and to the bony structure. In some implementations, users elect to allow a tooth-shaped soft abutment to remain secured to the implant long after osseointegration to intentionally delay placement of a traditional prosthesis. In some implementations, a tooth-shaped soft abutment is preferred as the permanent prosthesis, such as when the supporting bony structures are compromised, or for economy.

In some implementations, the durometer of the flexible abutment of the present invention is in the range of Shore 00 Scale between 10 and 100, and more preferably between 40 and 70. However, durometers outside that range can be considered to be effective for the purposes of the invention. Deflections under ambient loading forces allowable by the present flexible abutment are 0.5 mm or greater. Such deflections would generally be in the range of 0.75 mm to 3 mm or more, with typical deflections in the range of 1-2 mm. In some implementations, deflections of the incisal portions of tooth-shaped abutments could readily exceed 3 mm.

It is not obvious to use substantially soft, low durometer materials for implant healing abutments or prostheses for several reasons. Hard materials of the art match the materials used in implant fabrication, and are readily available in facilities that manufacture implants. Implant materials are selected for biocompatibility and strength, so healing and prosthetic abutments have traditionally been manufactured from the same materials to achieve biocompatibility and strength. Healing and prosthetic abutments are small in size, and detailed in configuration, so hard, homogenous, materials reduce complications in manufacturing. Hard healing and prosthetic abutments of the art are utilized with reasonable success after initial implant placements where initial stability is high, despite some failures with osseointegration. Ongoing advancements in elastomeric materials have recently made potential elastomeric abutments more practical and durable.

Analogous substantially soft temporary prostheses over preparations of natural teeth are impractical due to inherent difficulties in securing to the teeth. Some soft temporary restorative materials are utilized where significant undercuts are present in natural tooth preparations, such as for inlays and onlay preparations. Partly elastomeric temporary prosthetic materials of the art, such as acrylics, polycaprolactones, and so on, have substantially higher durometers than materials suitable for the present invention.

Substantially soft permanent prostheses for securing to natural teeth are undesirable due to several inherent obstacles. Such obstacles include unpredictability of securing such a prosthesis to the teeth, the lack of natural feel for the patient, long term maintenance obstacles, and cosmetic objections. The benefits of such soft prostheses are insignificant in comparison to these obstacles.

### BRIEF DESCRIPTION OF DRAWINGS

FIG. 1A is a cross-sectional view of a soft tooth-shaped healing abutment having an anti-rotational connector, and an implanted implant.

FIG. 1B is a cross-sectional view of a soft shell tooth healing abutment having a flexible facing, and having an anti-rotational connector, and an implanted implant.

FIG. 1C is a cross-sectional view of a soft shell abutment healing abutment having a flexible shell abutment, and having an anti-rotational connector, and an implanted implant.

FIG. 1D is a cross-sectional view of a soft hollow tooth healing abutment, and having an anti-rotational connector, and an implanted implant.

FIG. 2A is a cross-sectional view of a short shell abutment having an anti-rotational connector, and an implanted implant.

FIG. 2B is a cross-sectional view of a short shell abutment having a monolithic connector, and an implanted implant.

FIG. 3A is a cross-sectional view of a flexible cap having an anti-rotational connector, and an implanted implant.

FIG. 3B is a cross-sectional view of a flexible cap having a monolithic connector, and an implanted implant.

FIG. 4A is a cross-sectional view of an unexpanded expandable healing cap having a monolithic connector, and an implanted implant.

FIG. 4B is a cross-sectional view of an expanded expandable healing cap having a monolithic connector, and an implanted implant.

FIG. 5A is a cross-sectional view of a monolithic flexible cap having an elastomeric connector, and an implanted implant.

FIG. 5B is a cross-sectional view of a monolithic flexible cap having an undercut connector, and an implanted implant.

FIG. 6 is a cross-sectional view of a stratified abutment implant having a prosthetic abutment portion, and an implant portion.

### REFERENCE NUMERALS IN DRAWINGS

20 soft tooth
22A implant
22B implant
22C implant
24 tooth
26 osteotomy
28 gingiva
30 bony margin
32A platform
32B platform
32C platform
34A access hole
34B access hole
34C access hole
34D access hole
34E access hole
34F access hole
34G access hole
34H access hole
34-I access hole
34J access hole
34K access hole
36 screw
38 connector
40 external hex
42 internal hex
44 screw hole
46 shell tooth
48 shell
50A bulk
50B bulk
52 scanning features
54 shell tooth abutment
56 shell abutment
58 hollow tooth
60 hollow shell
62A short shell abutment
62B short shell abutment
64A short shell
64B short shell
66A soft filler
66B soft filler
68 scanning connector
70 scanning hex
72 unitary connector
74A extension
74B extension
74C extension
76A cylinder
76B cylinder
76C cylinder
78A drive socket
78B drive socket
80A flexible cap
80B flexible cap
82A soft cap
82B soft cap
84 expandable healing cap
86 expandable body
88 external wall
90 internal volume
92 top surface
94 surface features
96A monolithic flexible cap
96B monolithic flexible cap
98A monolithic body
98B monolithic body
100 undercut hex
102 tabs
104 hole undercut
106 stratified abutment implant
108 prosthetic abutment
110 internal drive
112 transitional zone

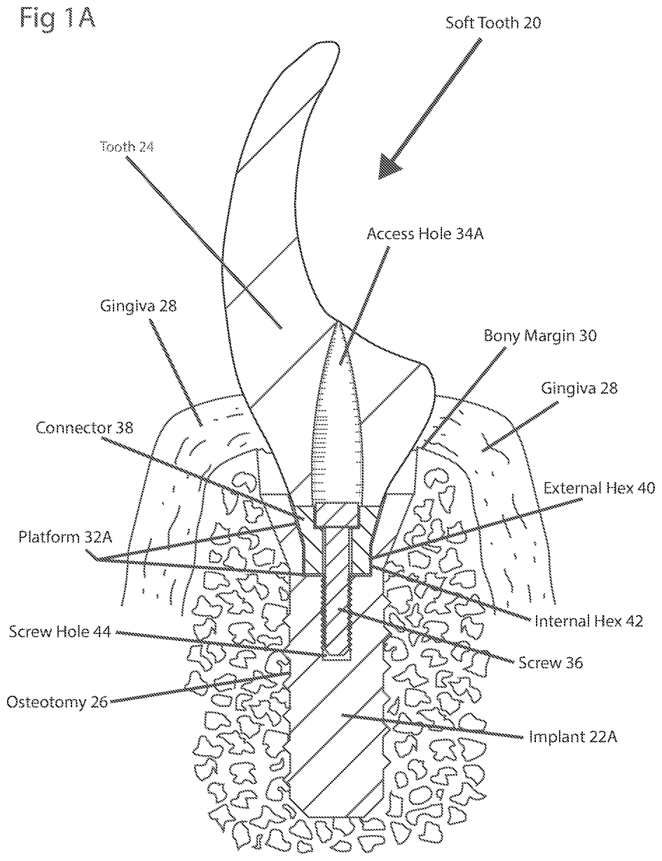

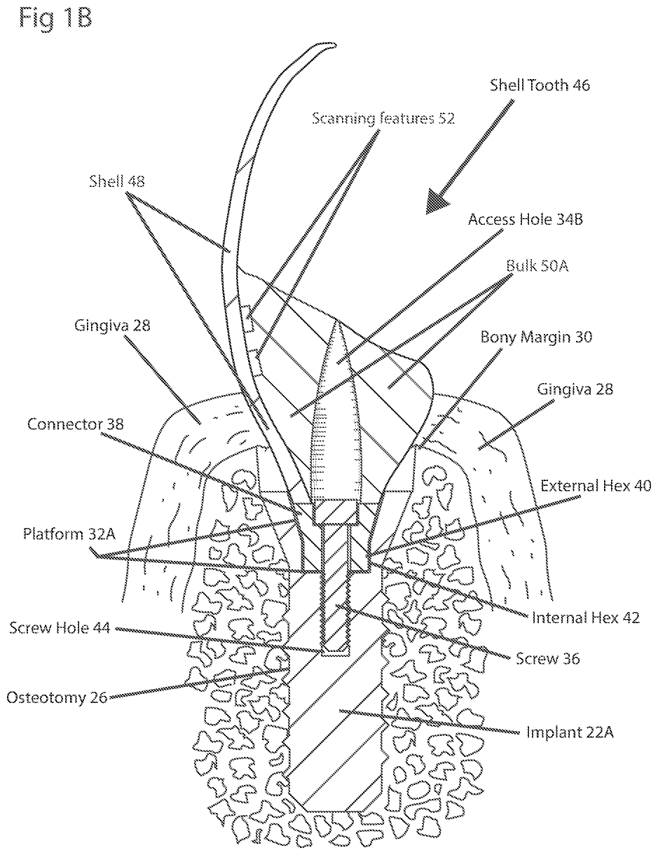

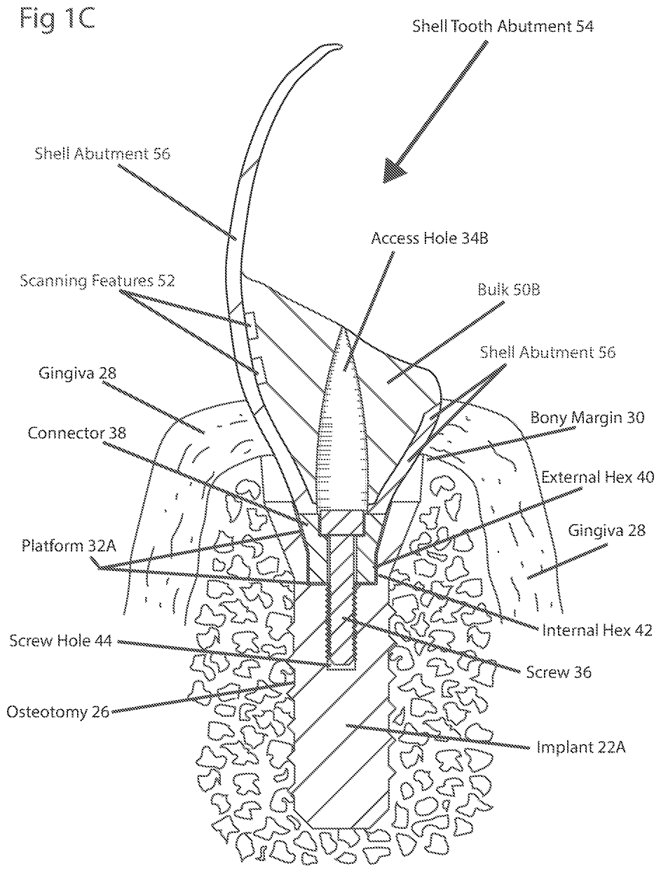

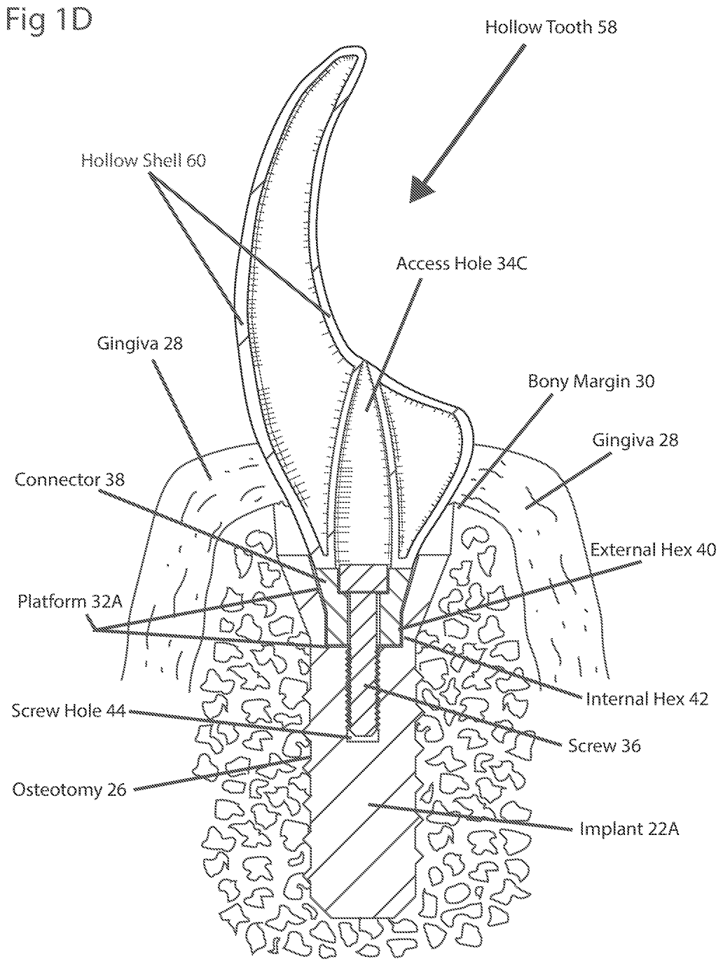

In accordance with an aspect and referring to FIG. 1A, there is provided a soft tooth 20 for securing to a dental implant 22A. Soft tooth 20 has a soft, elastomeric tooth 24 portion that is substantially flexible. The elastomeric material of tooth 24 has a sufficiently low durometer such that it readily deforms under a forceful load. When tooth 24 deforms and flexes under load, ambient forces impinging on any surface of tooth 24 are substantially absorbed and diffused by tooth 24.

Further, tooth 24 lacks higher durometer materials or structures a small distance under the surface of tooth 24. Substantially flexible materials are not limited to the surface layers of tooth 24, but also extend to a substantial depth below the surface of tooth 24. Tooth 24 is therefore configured to be substantially flexible throughout at least the greater portion of the volume of tooth 24.

After placement of implant 22A, a soft tooth 20 may be selected for cosmetic fit into the space to mimic a natural tooth. When soft tooth 20 is secured into implant 22A during the healing period, ambient forces impinging on soft tooth 20 are absorbed by the elastomeric tooth 24. Significantly less force is transferred to implant 22A, or to the healing osteotomy 26. As such, the chances of successful osseointegration of implant 22A may be increased.

The configuration of soft tooth 20 is such that the surrounding gingiva 28 is managed for healing to a desirable eminence profile. Further, the use of soft tooth 20 may negate the need for additional temporary appliances for use in cosmetically demanding sites.

When an attempt is made to seat soft tooth 20 into an implant where osteotomy 26 has a bony margin 30 that interferes with the path of insertion of soft tooth 20, then the tooth 24 will interferingly contact bony margin 30 so that a bony interference occurs. When the bony interference occurs against tooth 24, then bony margin 30 will readily cause a deformation of tooth 24. Due to such easy deformation of the lateral walls of tooth 24 during a bony interference, a significant premature increase in torque does not occur, such as those encountered with hard healing abutments of the art.

As such, the clinician does not sense a premature resistance to rotation when attempting to tighten and secure soft tooth 20. As such, the normal seating torque increase occurs only when soft tooth 20 is fully seating into implant 22A. The clinician is thus able to properly secure soft tooth 20 into platform 32A of implant 22A despite the presence of a bony interference to seating.

In some implementations, a soft tooth 20 having a given configuration is matched with an osteotomy 26 so that soft tooth 20 intentionally interferes with osteotomy bony margins 30 or with the bony walls of osteotomy 26. Such intentional interference with osteotomy 26 may be preferred in order to reduce interstitial spaces available to harbor bacteria and debris, to improve retention, to improve stability, and so on. For example, this may be preferred for some significantly subcrestal implant 22A placements.

In some implementations, the durometer of tooth 24 is selected to create a given level of pressure against osteotomy bony margins 30 to cause the bone of osteotomy 26 to pressure remodel and reshape to a desirable configuration. This may be desirable in order to insure proper seating of other devices into implant 22A, such as an impression coping, a scan body, a stability measurement peg, or a final prosthesis.

In some implementations, a soft tooth 20 having a given configuration is selected so as to intentionally interfere with at least the margins of platform 32A, or walls thereof. Such intentional interference with portions of platform 32A may be to reduce interstitial spaces available to harbor bacteria and debris, to improve retention, to improve stability, and so on.

In some implementations, an access hole 34A is provided through tooth 24 for permitting a drive tool access to a drive socket of a screw 36. As such, a drive tool is engageable with screw 36 for rotationally securing screw 36 into platform 32A, thereby securing or loosening soft tooth 20 with respect to platform 32A.

In some implementations, the upper, distal, open end of assess hole 34A may be configured as a slit shape so as minimize debris inadvertently entering therein. In some implementations, access hole 34A may be occludable with a soft cylindrical plug, or other means of reversibly occluding access hole 34A, such as during osseointegration time periods.

In some implementations, tooth 24 may be provided in a moldable state, such as a material that is moldable until exposed to a curing light, or other means of altering moldability. After tooth 24 is molded to a proper shape for gingival emergence profile or cosmetics, tooth 24 is then rendered substantially non-moldable. However, once tooth 24 is rendered substantially non-moldable, tooth 24 still remains substantially flexible.

A connector 38 secures tooth 24 to platform 32A. In some implementations, connector 38 is comprised of screw 36, an anti-rotational male external hex 40 for engaging into female internal hex 42 socket of platform 32A. As such, external hex 40 can key into internal hex 42 socket of platform 32A when seated to assure stable, specific rotational alignments of soft tooth 20 relative to platform 32A. The seated, keyed, external hex 40 is secured by securing screw 36 into screw hole 44 of platform 32A.

In some implementations, the facial surface of tooth 24 is comprised of a somewhat firmer material that is substantially flexible due to having a minimal thickness. However, the remaining bulk of material toward the lingual is comprised of a substantially soft material. In some implementations, the firmer facial layer of tooth 24 extends adjacent to connector 38. In some implementations, the firmer facial layer of tooth 24 is continuous with connector 38.

In some implementations, screw 36 is threaded and has a drive tool engaging means, such as an internal hex socket nested in the head of screw 36, or other means known in the art. In some implementations, screw 36 employs non-threaded connection means for engaging screw hole 44, such as spring-loaded prongs, or other securing means known in the art.

In accordance with an aspect and referring to FIG. 1B, there is provided a flexible shell tooth 46 that comprises a thin, facial shell 48 having minimal thickness, wherein shell 48 connects to connector 38, and wherein bulk 50A occupies the greatest portion of the material volume and surface area of shell tooth 46 that contacts gingiva 28 above connector 38. Bulk 50A also comprises the greatest portion of the material volume of shell tooth 46 that is exposed to the oral environment above gingiva 28.

Bulk 50A is comprised of soft, elastomeric material capable of absorbing ambient forces, and thereby reducing the forces transferred to implant 22A. Bulk 50A is comprised of materials that assist in forming a proper emergence profile of healing gingiva 28.

In some implementations, bulk 50A occupies a given volume of space lingual to shell 48, and above the surface of gingiva 28, and thereby occludes and fills in the lingual surface of shell 48. As such, bulk 50A is able to provide one of more of the functions of presenting the look and feel of a natural tooth, covering potentially irritating surface features on the lingual surface of shell 48, deflecting debris from the lingual surface of shell 48, protecting scan body features on the lingual surface of shell 48, and so on.

In some implementations, an access hole 34B in bulk 50A provides access to a screw 36 in connector 38. Screw 36 is secured into screw hole 44 of implant 22A, which is implanted into osteotomy 26.

Shell 48 is comprised of a somewhat firm but flexible material, such that ambient forces contacting bulk 50A or shell 48 will subsequently cause shell 48 to flex readily, thereby permitting shell tooth 46 to substantially absorb such forces in order to reduce forces transferred to implant 22A. In some implementations, shell 48 is comprised of the same material as connector 38.

In some implementations, shell 48 is comprised of thin layers of polycarbonate, polyester, polyethylene, and so on. In some implementations, at least the outer portion of shell 48 has a translucency that is similar to enamel. In some implementations, the portion of shell 48 below the outer translucent portion has a degree of opacity that is similar to dentin. In some implementations, bulk 50A has a degree of opacity that is similar to dentin.

In some implementations, the configurations of shell 48 and bulk 50A are customizable to fit the site, either during manufacture, or after manufacture. After manufacture customization includes relying on flexing of the flexible materials to automatically fit into spaces, material removal or addition by the clinician, rendering a moldable shell 48 or bulk 50A non-moldable after secured to implant 22A, and so on.

In some implementations, a portion of shell 48 has scanning features 52 such that 3D scanning thereof permits 3D locating of implant 22A for digital case planning and fabrication, such that shell tooth 46 is scannable. A scannable shell tooth 46 needs to be specifically oriented with respect to platform 32A, such as by having a specific orientation of external hex 40 with respect to internal hex 42.

If an interference with bony margin 30 occurs, shell 48 and bulk 50A will deform readily to facilitate proper securing to platform 32A.

In accordance with an aspect and referring to FIG. 1C, there is provided a flexible shell tooth abutment 54, comprising a thin, flexible shell abutment 56 having minimal thickness, wherein shell abutment 56 connects to connector 38. Shell abutment 56 comprises a thin facial shell portion, and comprises a thin, flexible perimeter extension portion that encompasses screw 36, and that defines an open central area. The facial shell portion of shell abutment 56 is substantially configured in the shape of a tooth, and contacts the gingiva 28 on the facial side of implant 22A.

The perimeter extension portion of shell abutment 56 comprises a thin, flexible perimeter extension that contacts the surrounding gingiva 28 other than that contacted by the facial shell portion. The thin, flexible perimeter extension portion of shell abutment 56 readily flexes when loaded by ambient forces, and absorbs such forces, thereby reducing forces transferred to implant 22A and osteotomy 26. The clinician has the ability to customize at least the height of the thin perimeter extension in order to minimize ambient forces transferable to the connector and platform, and to manage the emergence profile healing. Other dimensions of the shell abutment 56 may also be customizable.

The central open central area provides access for screw 36. In some implementations, the open central area of the perimeter extension is substantially occluded with soft, flexible filler, bulk 50B. In some implementations, bulk 50B covers and fills portions of the lingual side of shell abutment 56, similarly to that described for shell tooth 46. In some implementations, access hole 34B is provided through bulk 50B to provide access to screw 36, which is shown secured into screw hole 44.

In some implementations, a portion of shell abutment 56 has scanning features 52 such that 3D scanning thereof permits 3D locating of implant 22A for digital case planning and fabrication, such that shell tooth abutment 54 is scannable. A scannable shell tooth abutment 54 needs to be specifically oriented with respect to platform 32A, such as by having a specific orientation of external hex 40 with respect to internal hex 42.

In some implementations, shell abutment 56 is comprised of thin layers of polycarbonate, polyester, polyethylene, and so on.

If an interference with bony margin 30 occurs, shell abutment 56 will deform readily to facilitate proper securing to platform 32A.

In accordance with an aspect and referring to FIG. 1D, there is provided a flexible hollow tooth 58 comprising a flexible wall, called hollow shell 60, that is substantially configured in the shape of a tooth, and comprising a connector 38. Connector 38 has an external hex 40 anti-rotationally nested into internal hex 42. In some implementations, a screw 36 secures hollow tooth 58 into screw hole 44 of implant 22A.

In some implementations, the flexible wall of hollow shell 60 is comprised of a soft, low durometer material that remains soft, and flexes readily under load at any given thickness of the material.

In some implementations, the flexible wall of hollow shell 60 has a degree of rigidity, wherein the material would otherwise have significant rigidity at a given greater dimensional thickness. However, at the provided thickness, the flexible wall is sufficiently thin so as to remain substantially flexible, and to deform readily under load. As such, hollow shell 60 responds to forces similarly to a lower durometer material, and reduces forces transferred to implant 22A and osteotomy 26. In some implementations, hollow shell 60 is comprised of thin layers of polycarbonate, polyester, polyethylene, and so on.

In some implementations, hollow shell 60 is gas filled, or liquid filled, or microparticulate filled, and so on. In some implementations, hollow shell 60 is comprised of an elastic material that is readily stretchable. In some implementations, hollow shell 60 is evacuated, and the configuration of hollow shell 60 is fabricated to resemble a tooth only after sufficient inflation, such as with a gas, liquid, or particulate. In some implementations, hollow shell 60 has an access hole 34C.

Hollow shell 60 contacts gingiva 28, and controls the healing shape thereof. If an interference with bony margin 30 occurs, hollow shell 60 will deform readily to facilitate proper securing to platform 32A.

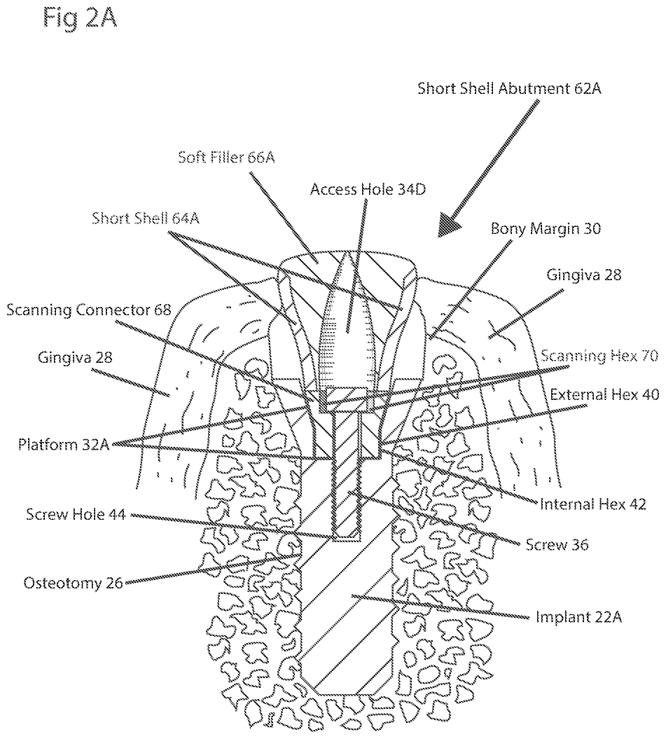

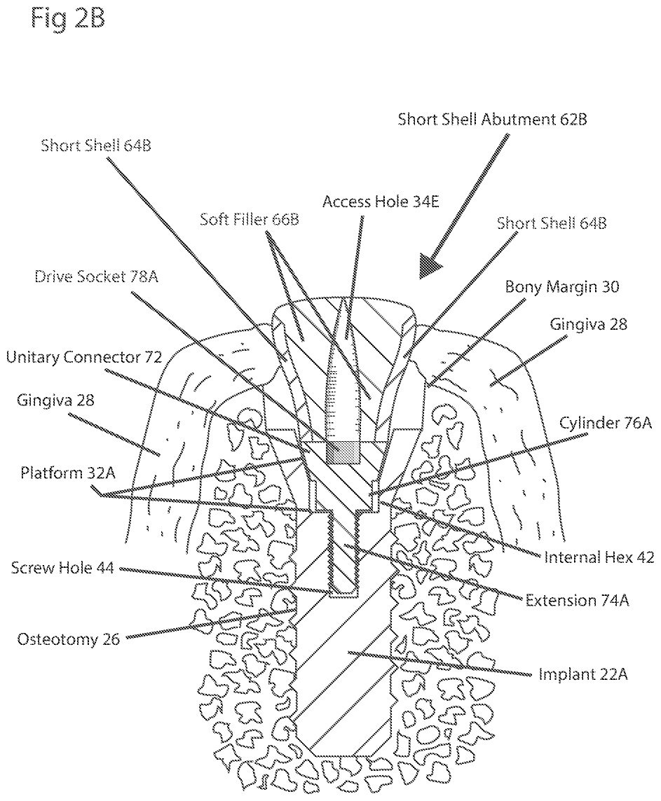

In accordance with an aspect and referring to FIG. 2A, there is provided a short shell abutment 62A comprising a short shell 64A that defines an open central area, and contacts the surrounding gingiva 28, and comprising a scanning connector 68 having a scanning hex 70. Short shell 64A is thin and flexible, and readily flexes when loaded by ambient forces, and substantially absorbs such forces. As such, short shell 64A reduces forces transferred to implant 22A and osteotomy 26. The clinician is able to customize at least the height of short shell 64A to minimize ambient forces transferable to implant 22A, and to manage the emergence profile healing of gingiva 28. Other customizations may be performed in the manner described for other iterations of the soft abutment.

In some implementations, the open central area of the perimeter extension is substantially filled with soft filler 66A during manufacturing. In some implementations, the open central area of the perimeter extension is substantially filled with soft filler 66A after short shell abutment 62A is secured to platform 32A. In some implementations, access hole 34D is provided through soft filler 66A to provide access to screw 36 for securing or removing from screw hole 44.

In some implementations, soft filler 66A is replaceably removable by the clinician, such as for stabilization assessment, taking impressions, for scanning features located on the inner surface short shell 64A, or for removing short shell abutment 62A from platform 32A.

Scanning connector 68 comprises a screw 36, and an external hex 40 for nesting into internal hex 42, such that short shell abutment 62A is anti-rotationally keyable into platform 32A. In some implementations, a scan body is connectable to short shell abutment 62A, such as by removing screw 36 while leaving short shell abutment 62A in place on platform 32A, pushing the scan body through access hole 34D, and then seating the scan body into scanning hex 70. As such, the scan body is anti-rotationally keyed with short shell abutment 62A, and therefore with platform 32A. Once scanning is completed, the scan body is removed from scanning hex 70, and screw 36 is replaced to secure short shell abutment 62A to platform 32A.

In some implementations, short shell 64A has a custom configuration to replicate the emergence profile of individual teeth. In some implementations, short shell 64A is manufactured in stock sizes and configurations.

If an interference with bony margin 30 occurs, short shell 64A will deform readily to facilitate proper securing to platform 32A.

In accordance with an aspect and referring to FIG. 2B, there is provided a short shell abutment 62B that defines an open central area, and contacts the surrounding gingiva 28, and comprising a short shell 64B, and a unitary connector 72. Unitary connector 72 comprises an extension 74A, and comprises a cylinder 76A that is engageable into internal hex 42 of platform 32A.

Cylinder 76A is rotationally engageable into internal hex 42, so that cylinder 76A is able to be rotated while nested into internal hex 42. As such, short shell abutment 62B is able to be rotated in order to secure extension 74A into screw hole 44. The final secured rotation of short shell abutment 62B is not indexed to the rotation of internal hex 42, or of implant 22A, and is therefore not intended to be predictable. Short shell abutment 62B therefore lacks anti-rotational capability with respect to platform 32A.

Unitary connector 72 also comprises a drive socket 78A for engaging a drive tool, such as via access hole 34E. Drive socket 78A may be configured as a hex drive socket, or other drive tool engaging means known in the art.

Short shell 64B is thin and flexible, and readily flexes when loaded by ambient forces, and absorbs such forces. As such, short shell 64B reduces forces transferred to implant 22A and osteotomy 26. The clinician is able to customize at least the height of short shell 64B to minimize ambient forces transferable to implant 22A, and to manage the emergence profile healing of gingiva 28.

In some implementations, the open central area of the perimeter extension is substantially filled with soft filler 66B during manufacturing. In some implementations, the open central area of short shell 64B is substantially filled with soft filler 66B after short shell abutment 62B is secured to platform 32A. In some implementations, soft filler 66B is replaceably removable by the clinician, such as for stabilization assessment. In some implementations, access hole 34E is provided through soft filler 66A to provide access to drive socket 78A.

In some implementations, unitary connector 72 may include non-thread connection means of the art in lieu of extension 74A, such as flexible undercut members that engage platform 32A.

If an interference with bony margin 30 occurs, short shell 64B will deform readily to facilitate proper securing to platform 32A.

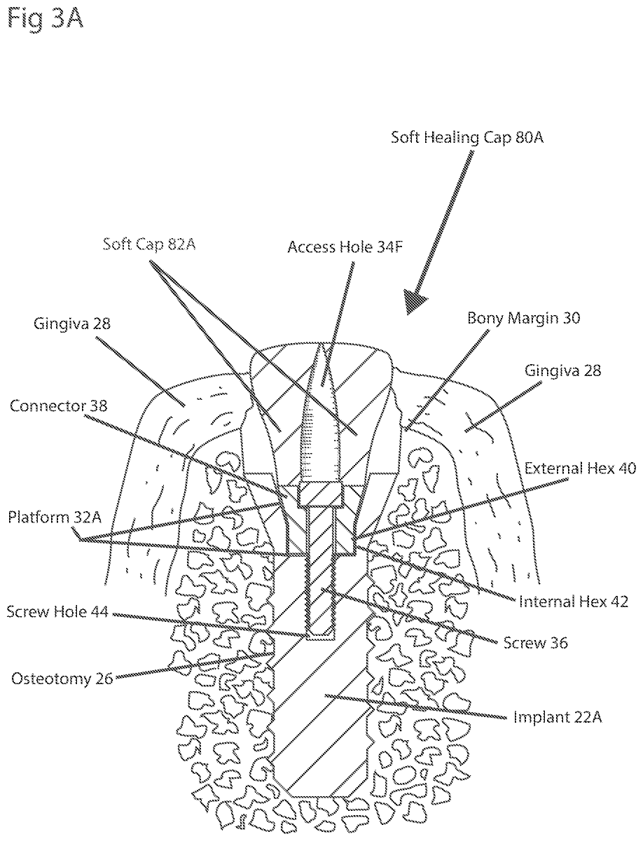

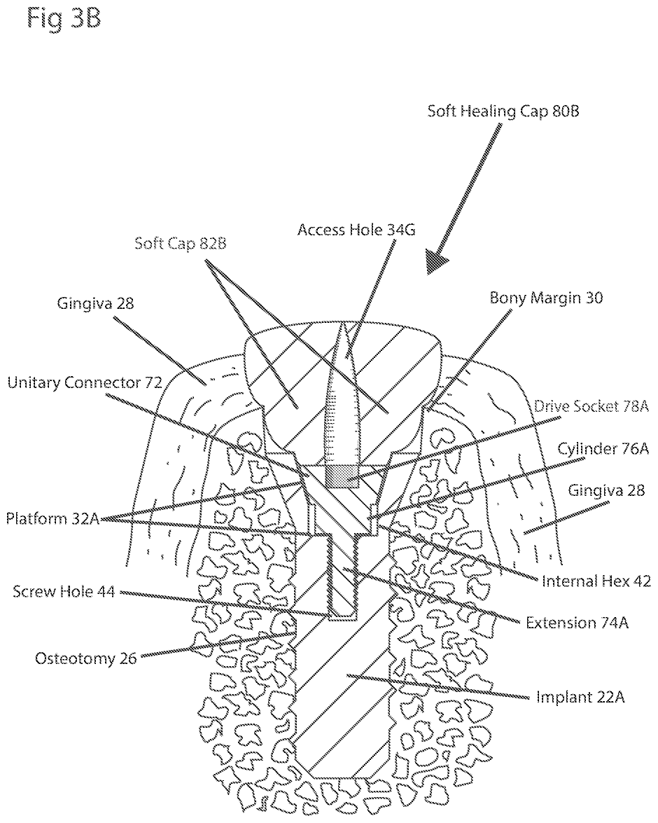

In accordance with an aspect and referring to FIG. 3A, there is provided a flexible cap 80A comprising a soft cap 82A, and a connector 38. Soft cap 82A is configured to substantially occupy the space over platform 32A in order to contact gingiva 28, and to manage gingiva 28 healing after implant 22A placement, wherein the size and shape of soft cap 82A is selected by the clinician such that it protrudes only a slightly distance above the surface of surrounding gingiva 28. The distance that soft cap 82A protrudes above gingiva 28 is sufficient such that gingiva 28 is unlikely to heal over soft cap 82A, or to otherwise cover soft cap 82A. The distance that the soft cap 82A protrudes above gingiva 28 is also minimized such that ambient forces brought to bear on soft cap 82A are minimized. In some implementations, the size and shape of flexible cap 80A is customizable. Flexible cap 80A substantially absorbs ambient forces thereon, and minimizes forces transferred thereby to healing implant 22A and osteotomy 26.

Connector 38 has an external hex 40 for anti-rotationally keying into internal hex 42 of platform 32A of implant 22A. A drive tool is insertable into access hole 34F for engaging and securing screw 36 into screw hole 44, thereby securing flexible cap 80A to platform 32A.

If an interference with bony margin 30 occurs, soft cap 82A will deform readily to facilitate proper securing to platform 32A.

In accordance with an aspect and referring to FIG. 3B, there is provided a flexible cap 80B comprising a soft cap 82B, and comprising a unitary connector 72. Unitary connector 72 has a cylinder 76A seated into internal hex 42 of platform 32A without anti-rotational capability. Soft cap 82B is configured to substantially occupy the space over platform 32A in order to contact gingiva 28, and to manage gingiva 28 healing after implant 22A placement, wherein the size and shape of soft cap 82B is selected by the clinician such that it protrudes only a slightly distance above the surface of surrounding gingiva 28.

Cylinder 76A is rotationally engageable into internal hex 42, so that cylinder 76A is able to be rotated while nested into internal hex 42, such as during rotation of flexible cap 80B in order to secure extension 74A into screw hole 44. As such, the final secured rotation of flexible cap 80B is not keyed to the rotation of internal hex 42, or of implant 22A. flexible cap 80B therefore lacks anti-rotational keying with respect to platform 32A.

Drive socket 78A provides engagement for a drive tool, such as through an access hole 34G to secure extension 74A into screw hole 44. Flexible cap 80B is typically fabricated in stock sizes, and is typically symmetrical about a vertical axis. However, flexible cap 80B may be custom manufactured, or may be customizable before or after securing to implant 22A.

FIG. 3B shows flexible cap 80B fully seated into implant 22A despite soft cap 82B flexingly interfering with platform 32A and with bony margin 30. The interferences have readily indented and deformed the surface configuration of soft cap 82B, such that the forces required to deform soft cap 82B result in only substantially insignificant resistance to the rotation of flexible cap 80B while securing to implant 22A.

In the drawing, the interferences are depicted as slight indentations of the external surface of soft cap 82B, in contrast with the smooth, non-indented surface of non-interfering soft cap 82A depicted in FIG. 3A. As such, the interference of soft cap 82B with platform 32A, and with bony margin 30, does not significantly inhibit full seating and securing of flexible cap 80B to implant 22A.

As such, flexible cap 80B substantially absorbs ambient forces thereon, and minimizes forces transferred thereby to healing implant 22A and osteotomy 26.

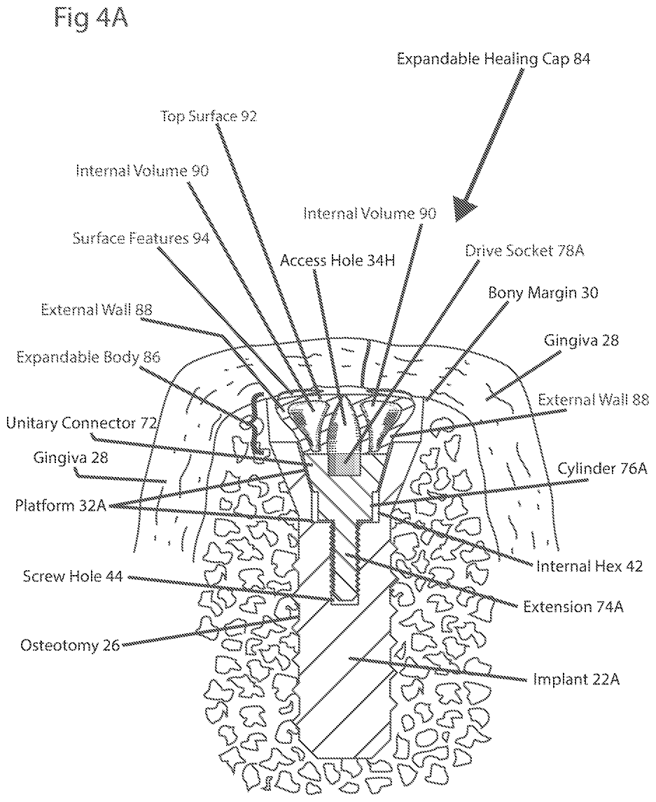

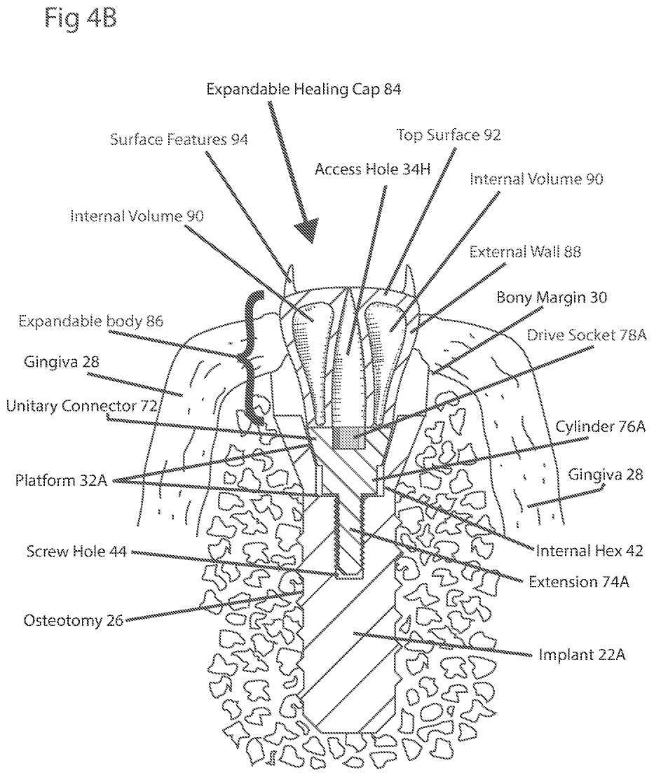

In accordance with an aspect and referring to FIG. 4A, there is provided an expandable healing cap 84 for occupying space over implant 22A implanted into osteotomy 26. Expandable healing cap 84 comprises an expandable body 86 that is expandable or distendable, and comprises a unitary connector 72. Cylinder 76A is seated into internal hex 42. Expandable healing cap 84 is provided unexpanded, such that the overall size is sufficiently small so as to permit closure and covering by gingiva 28 after securing to implant 22A. An access hole 34H through expandable body 86 permits insertion of a drive tool for engaging drive socket 78A, and for rotationally securing extension 74A into screw hole 44.

Expandable body 86 has an external wall 88 that resists leakage of fluids or gasses, especially during pressurization, stretching, and distension thereof. An internal volume 90 is capable of containing fluids, gasses, absorptive material, and so on. Internal volume 90 may comprise as a hollow internal portion, an open-cell spongey portion, and so on. In some implementations, fluid or gas forcefully injected into internal volume 90 pressurizes internal volume 90. In some implementations, absorbent materials absorb fluids from gingiva 28, wherein the volume of such absorbent materials substantially expands when fluids are absorbed, such that internal volume 90 is pressurized.

Such pressurization of internal volume 90 causes stretching and enlargement of external wall 88. As such, the size and shape of expandable body 86 is adjustable by adding or subtracting fluid, gas, or by containing an amount of absorbent material.

External wall 88 of expandable body 86 is configured to facilitate controlled enlargement of expandable body 86, such that the enlargement thereof causes top surface 92 to move away from unitary connector 72, and press forcefully against the gingiva 28 that is covering expandable body 86.

In some implementations, the controlled enlargement is such that it facilitates achieving a desirable final expanded shape of expandable body 86, such as a shape that would cause gingiva 28 to remodel to create a desirable emergence profile.

Such controlled stretching and enlargement is achieved by configuring external wall 88 so that some portions of external wall 88 have relatively high flexibility or thicknesses, while other portions of external wall 88 have relatively lower flexibility or thicknesses. Configuration of expandable body 86 includes selecting the shape, durometer, elasticity, thickness, and so on. Top surface 92 is further configured so as to resist fluid leakage after puncture by a needle, similarly to the function of a medicine vial stopper.

In some implementations, internal volume 90 is preloaded with a small volume of liquid dye or gas that may be aspirated into a needle to act as an indicator means for correct needle tip placement into internal volume 90. For example, the aspiration of a blue or green dye into a needle would be followed by the injection of a given volume of fluid into internal volume 90 of expandable body 86 in order to inflate expandable healing cap 84.

In some implementations, external wall 88 is comprised of non-permeable elastomeric materials. In some implementations, external wall 88 is comprised of semi-permeable or permeable elastomeric materials. In some implementations where external wall 88 is comprised of a semi-permeable material, then the ingress of ambient fluids into internal volume 90 is gradual over an extended period. As such, expandable fluid absorbent materials therein gradually absorb fluids over an extended period, and therefore gradually expand over an extended period. The gradual expansion of the absorbent materials pressurizes and distends external wall 88. As such, expandable healing cap 84 gradually expands to a preferred size and shape configuration. The final configuration of an expanded expandable healing cap 84 is controllable by the volume and type of expandable absorbent contained in internal volume 90.

In some implementations, external wall 88 is comprised of a dissolvable material. After at least a portion of dissolvable external wall 88 dissolves, then ambient fluids breach into internal volume 90. Fluids breaching into internal volume 90 are then absorbable by absorbent materials contained in internal volume 90. In some implementations, the portion external wall 88 where the breach is most likely to occur may be thinner than other portions, and selected to facilitate controlled expansion of expandable body 86. Suitable dissolvable materials of external wall 88 include gut, cellulose, and other slowly dissolvable materials known in the art.

In some implementations, expandable body 86 has at least one dissolvable plug that dissolves over time to provide an opening for ambient fluids from gingiva 28 to enter therein, and be absorbed into absorbent materials contained in internal volume 90.

In some implementations, expandable body 86 is comprised of a material that is a substantially homogenous absorbent that does not require barrier isolation or containment by an external wall 88. The homogenous absorbent material is capable of absorbing ambient fluids over a time period, and resists dissolution. As such, the homogeneous expandable body 86 expands at a preferred rate so as to permit sufficient osseointegration prior to transmucosally sloughing the gingiva 28 covering. Analogous absorbents are used as gastric obesity therapies, and so on, such as absorbent hydrogels, and so on. In some implementations, such absorbent materials may be laced with structural binders for controlling fluid uptake by the absorbent materials, and for maintaining the expanding configurations of the expanding expandable body 86.

In some implementations, top surface 92 has surface features 94 that facilitate gingival sloughing, such as after pressurization of expandable body 86. In some implementations, surface features 94 comprise sharp protrusions having a higher rigidity relative to expandable body 86. FIG. 4A shows surface features 94 in a relatively horizontal and undeployed angulation. In some implementations, surface features 94 comprise sharp protrusions which do not protrude from top surface 92 prior to pressurization, but only after pressurization. In some implementations, such pressurization causes sharp-protrusion style surface features 94 to become deployed, such as by changing the angulation of the protrusions from a horizontal angulation to a vertical angulation relative to top surface 92. Such angulation changes can be affected by unfolding surface features 94, by protruding out from a retracted or nested position, by telescoping, or other means of deploying surface features 94.

If an interference with bony margin 30 occurs, expandable body 86 will deform readily, such as to facilitate proper securing to platform 32A.

FIG. 4B shows an expandable healing cap 84 secured to implant 22A, where implant 22A is implanted into osteotomy 26. Expandable healing cap 84 has an expanded expandable body 86 transmucosally protruding through sloughed gingiva 28, and exposed to the oral cavity.

Internal volume 90 is pressurized such as with an injected fluid or gas, or with expanded absorbent, such that external wall 88 is distended to a preferred configuration, thereby properly forming the emergence profile of gingiva 28. Top surface 92 has protruded through gingiva 28, and is exposed to the oral cavity. Surface features 94 are in a relatively vertical, deployed, orientation due to the inflation and distension of expandable body 86.

Extension 74A of unitary connector 72 is securely engaged into screw hole 44. A drive tool has been removed from engaging drive socket 78A, and withdrawn from access hole 34H. Cylinder 76A is seated into internal hex 42.

If an interference with bony margin 30 occurs, expandable body 86 will deform readily to facilitate proper securing to platform 32A.

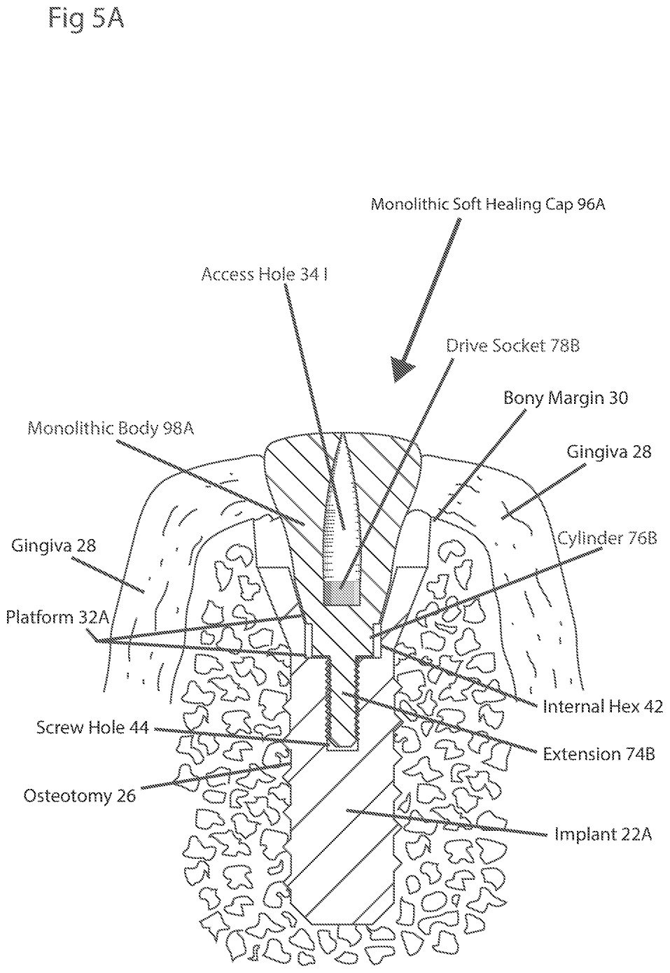

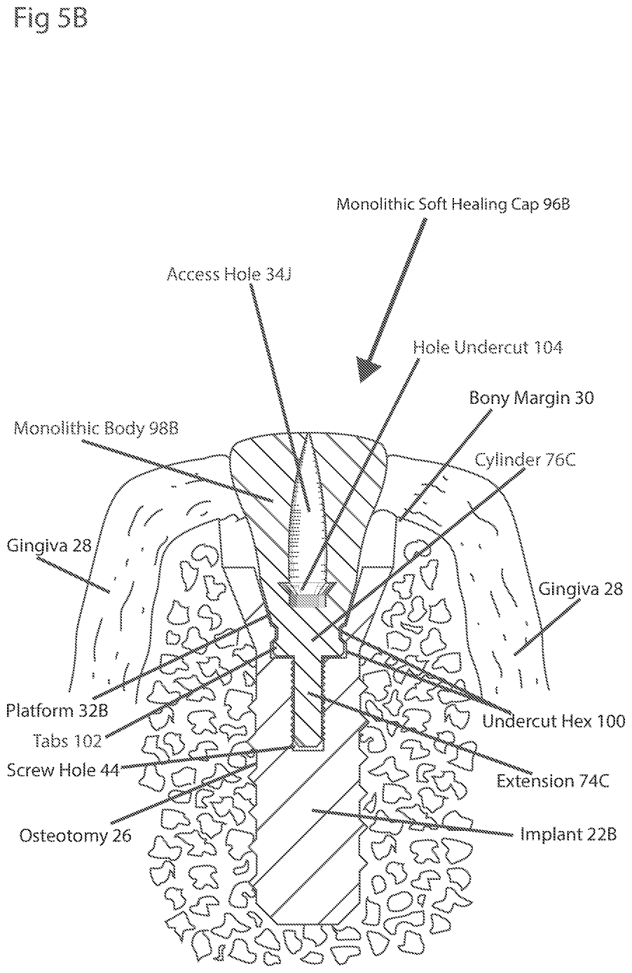

In accordance with an aspect and referring to FIG. 5A, there is provided monolithic flexible cap 96A is entirely comprised of elastomeric material. Monolithic flexible cap 96A is comprised of elastomeric monolithic body 98A, and elastomeric cylinder 76B that nests into internal hex 42. An elastomeric extension 74B protrudes from cylinder 76B, and is inserted into screw hole 44. Monolithic flexible cap 96A is shown sufficiently detachably connected to implant 22A to predictably secure monolithic flexible cap 96A to implant 22A. Gingiva 28 is shown contacting monolithic body 98A, but not bony margin 30 of osteotomy 26.

In some implementations, the durometer of elasticity is uniform throughout monolithic flexible cap 96A. In some implementations, the durometer, or degree of elasticity, varies over different portions of monolithic flexible cap 96A. In some implementations, the durometer is lower in the portions of flexible cap 96A that are distal from platform 32A, and the durometer is higher in portions more proximal to platform 32A. As such, durometers of cylinder 76B and of extension 74B may be substantially higher than monolithic body 98A.

Drive socket 78B is engageable with an insertion tool via access hole 34-I for rotating and securing monolithic flexible cap 96A to implant 22A. In some implementations, drive socket 78B is continuous with the material of monolithic body 98A. In some implementations, the material of monolithic body 98A has higher durometer in the portion proximal to drive socket 78B than in portions more distal from platform 32A. In some implementations, drive socket 78B is comprised of a different material than monolithic body 98A.

In some implementations, extension 74B has a threaded surface for engaging the threads of screw hole 44, such that monolithic flexible cap 96A is rotated to secure to implant 22A. In some implementations, extension 74B has a non-threaded surface, such that an inserted extension 74B engages the threads of screw hole 44 by compression deformation. As such, monolithic flexible cap 96A may be secured to implant 22A by placing extension 74B into the orifice of screw hole 44, and then pushing extension 74B into screw hole 44, without rotation, until monolithic flexible cap 96A is properly seating into platform 32A and screw hole 44. However, threaded extension 74B may similarly be inserted by pushing vertically without rotation in order to be inserted into screw hole 44, such as by elastic deformation of the threads thereof. Such elastic deformation of the threads of a threaded extension 74B permits flexing of the threads thereof, and facilitates removably retentive insertion into screw hole 44.

In some implementations, extension 74B is non-threaded, and also does not significantly engage the threads of screw hole 44 by compression deformation. In some implementations, extension 74B has a shortened configuration, or is substantially absent from monolithic flexible cap 96A. In some implementations, a removable adhesive material is introduced to enhance secure retention of monolithic flexible cap 96A to platform 32A, such that the adhesive is removable from platform 32A or screw hole 44 prior to securing a prosthesis to implant 22A.

The combination of cylinder 76B, drive socket 78B, and the lower proximal portions of monolithic body 98A, can be considered to be a type of connector that is analogous to those shown in other implementations. Such a connector is considered to be an elastomeric connector of monolithic flexible cap 96A.

In accordance with an aspect and referring to FIG. 5B, there is provided a monolithic flexible cap 96B is entirely comprised of elastomeric material. Monolithic flexible cap 96B is comprised of an elastomeric monolithic body 98B, and an elastomeric cylinder 76C that is nested into undercut hex 100 of platform 32B. Monolithic flexible cap 96B is shown sufficiently detachably connected to implant 22B to predictably secure monolithic flexible cap 96B to implant 22B. Gingiva 28 is shown contacting monolithic body 98B, but not bony margin 30 of osteotomy 26.

Elastomeric tabs 102 protrude laterally from cylinder 76C, and nest into mating lateral undercuts of undercut hex 100. When tabs 102 are nested into mating undercuts of undercut hex 100, then cylinder 76C is detachably retainable with undercuts of undercut hex 100. When tabs 102 are mated into undercut hex 100, then monolithic flexible cap 96B is detachably connected with platform 32B.

Access hole 34J provides access for a seating tool to be inserted into monolithic flexible cap 96B for forcefully seating cylinder 76C into platform 32B. Monolithic flexible cap 96B is thereby secured to platform 32B by pushing with the seating tool, or by pushing thereto with finger pressure, or by pushing with other means. As such, when monolithic flexible cap 96B is securely seated into platform 32B, and monolithic flexible cap 96B is thereby removably retained by platform 32B, and is rotatable with respect to platform 32B.

In some implementations, hole undercut 104 has a multiplicity of flanks and corners to facilitate the rotation of monolithic flexible cap 96B during seating thereof into platform 32B, such as an internal hex configuration. Such rotation of monolithic flexible cap 96B can facilitate full decompression of tabs 102, and therefore proper mating engagement of tabs 102, into undercuts of undercut hex 100. In some implementations, the insertion tool has matching mating flanks and corners for rotationally engaging hole undercut 104.

A hole undercut 104 is located at the bottom of access hole 34J, and at least a portion of hole undercut 104 has a diameter that is greater than that of access hole 34J. When removal of monolithic flexible cap 96B is indicated, then a customized removal tool is inserted into access hole 34J, such that hole undercut 104 is retentively engaged with the removal tool. When the removal tool is forcefully moved away from platform 32B, then the retentive engagement with hole undercut 104 is sufficient to causes cylinder 76C to move away from platform 32B, and causes tabs 102 to flex downward and out from under the undercuts of undercut hex 100, thereby releasing the retention of tabs 102 from undercut hex 100. As such, monolithic flexible cap 96B is released from retention with platform 32B and implant 22B, and thereby detached from implant 22B. In some implementations, the removal tool is removable from the retention of hole undercut 104 and access hole 34J without significant damage to monolithic body 98B. In some implementations, after release, monolithic flexible cap 96B may be retentively reseated into platform 32B.

An extension 74C protrudes from cylinder 76C, and is inserted into screw hole 44. In some implementations, extension 74C has a smooth surface, and substantially does not engage the threads of screw hole 44. In some implementations, extension 74C somewhat engages the threads of screw hole 44, such as when extension 74C is pressed into screw hole 44 without rotation. In some implementations, extension 74C has threads fully engage the threads of screw hole 44, and require rotation of monolithic flexible cap 96B to screw extension 74C into screw hole 44. In some implementations, extension 74C is shortened, or substantially absent.

In some implementations, tabs 102 are located at a higher vertical location relative to the floor of platform 32B, and the corresponding undercuts associated with platform 32B are also located at the appropriate vertical height for mating with tabs 102. As such, the lower end of cylinder 76C is able to enter and nest into undercut hex 100 prior to tabs 102 contacting the surface thereof. Such a configuration may facilitate easy alignment and seating of cylinder 76C into undercut hex 100.

In some implementations, the undercuts of undercut hex 100 are located under the hex flanks thereof, such that the maximum circumference of undercut hex 100 remains unchanged by the presence of the undercuts. As such, the hex corners of undercut hex 100 are therefore not undercut. In some implementations, both the hex corners and the hex flanks of undercut hex 100 are undercut, and the maximum circumference of undercut hex 100 is therefore increased.

In some implementations, tabs 102 are uninterrupted, and comprise a continuous ring that protrudes laterally from elastic cylinder 76C. In some implementations, cylinder 76C has an smooth cylindrical external surface that does not fully contact the flanks of undercut hex 100, so that monolithic healing cap 96B is free to rotate to any rotational angle while securing to platform 32B.

In some implementations, the locations and number of tabs 102 are fewer than the number of flanks of undercut hex 100. In some implementations, only two tabs 102 are located on opposite sides of cylinder 76C. In some implementations, only three tabs 102 are around the circumference of cylinder 76C, with even spacing between individual tabs 102. The limited tabs 102 would be for engaging corresponding limited mating undercuts of undercut hex 100. When limited tabs 102 are engaged into corresponding mating undercuts of undercut hex 100, then monolithic healing cap 96B is anti-rotationally keyed to platform 32B. In some implementations, cylinder 76C has an external hex configuration for more fully engaging the flanks of undercut hex 100, and monolithic healing cap 96B is anti-rotationally keyed to platform 32B. As such, the rotation angle of monolithic healing cap 96B and of tabs 102 must be rotationally aligned with the mating undercuts of undercut hex 100 for proper engagement of tabs 102 therein.

The combination of cylinder 76C, hole undercut 104, and the lower proximal portions of monolithic body 98B, can be considered to be a type of connector that is analogous to those connectors shown in other implementations. Such a connector is considered to be an elastomeric connector of monolithic flexible cap 96B.

In some implementations, a monolithic flexible cap 96B is substantially tooth-shaped, and is removably detachable from platform 32B by a clinician or by a patient. In some implementations, hole undercut 104 is absent. In some implementations, a tooth-shaped monolithic flexible cap 96B has a flexible facing shell.

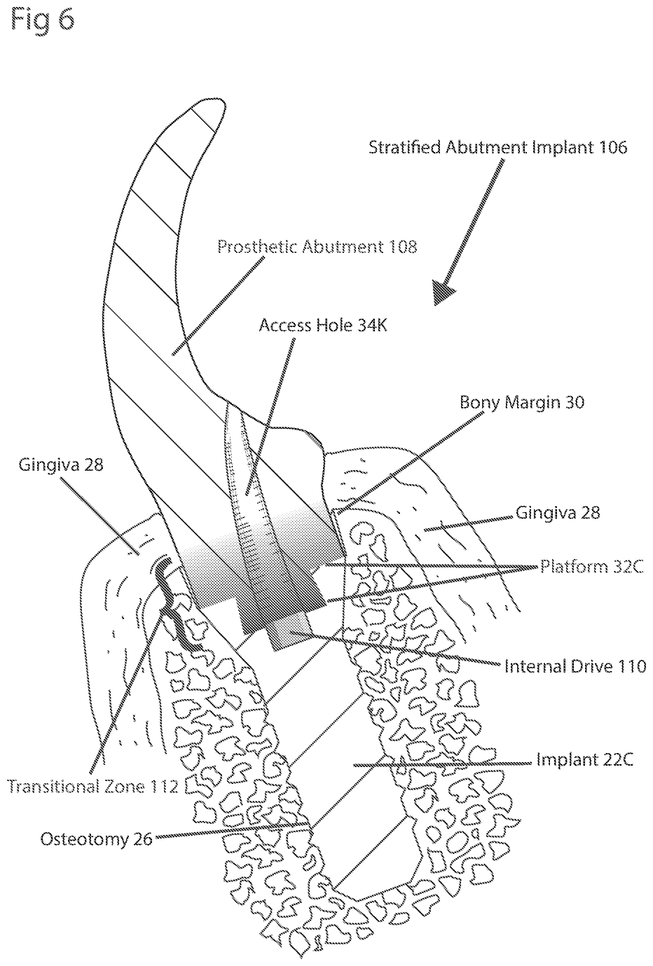

In accordance with an aspect and referring to FIG. 6, there is provided a stratified abutment implant 106 comprising a substantially flexible prosthetic abutment 108 that is manufactured to be combined with implant 22c, and thereby is substantially integrated with implant 22C. As such, prosthetic abutment 108 is not readily detachable from implant 22C, and is integral with implant 22C. As such, stratified abutment implant 106 comprises an implant-soft abutment combination.

In some implementations, the manufacture of stratified abutment implant 106 is a substantially continuous process, such as by printing implant 22C and also printing prosthetic abutment 108 without substantial interruption in the manufacturing process, or other manufacturing processes. In some implementations, the manufacture of implant 22 is completed prior to the manufacture of prosthetic abutment 108.

During manufacture of at least prosthetic abutment 108, a portion of prosthetic abutment 108 comprises layers of materials having differing properties are deposited, resulting in a generalized stratification of the materials, where the portion is called transition zone 112. In some implementations, transition zone 112 is comprised of more rigid materials in the portions adjacent to platform 32C of implant 22C, and less rigid in portions more distal from platform 32C. As such, the materials of transition zone 112 have increased rigidity and strength, and are less prone to physical failure. In some implementations, platform 32C has macro-undercuts or micro-undercuts for mechanically retaining elements of transition zone 112, in addition to any adhesive bond thereto.

Stratified abutment implant 106 has significantly fewer interstitial voids that could permit bacterial contamination. In some implementations, stratified abutment implant 106 is more economically manufacturable, and also economically insertable relative to implants and abutments of the art.

In some implementations, at least a portion of prosthetic abutment 108 is detachable from stratified abutment implant 106, such as to manage insertion, healing, to manage hygiene, for esthetic corrections, and so on. In some implementations, prosthetic abutment 108 is entirely detachable from stratified abutment implant 106, such that a different prosthesis may be connected thereto.

In some implementations, stratified abutment implant 106 is insertable into osteotomy 26 by a series of 360 degree rotations for achieving a preferred depth of insertion, where the final 360 degree rotation ends with correct alignment of prosthetic abutment 108 with adjacent teeth. During such rotations, the flexibility of prosthetic abutment 108 is flexible facilitates rotations despite interferences with adjacent teeth.

In some implementations, access hole 34K is substantially curved to compensate for a difference in the angulation of implant 22C relative to the angulation of prosthetic abutment 108. Such a curved access hole 34K has an orifice located on the lingual side of prosthetic abutment 108. A driver is thereby insertable by flexing the incisal portion of prosthetic abutment 108 toward the facial to provide a straight-line path of insertion for the driver tool for engaging internal drive 110.

In some implementations, stratified abutment implant 106 is insertable into a bony socket by vertical insertion, and without rotation thereof, such as when implant 22C is asymmetrical, or is substantially tooth-shaped. Once stratified abutment implant 106 is inserted into a bony socket, ambient forces are substantially absorbed by prosthetic abutment 108, such that forces transferred to implant 22C and the bony socket are substantially reduced. As such, healing of the bony socket is facilitates, and trauma to the bony socket after healing has completed is similarly reduced.

All flexible abutment variations may include a connector 38, a scanning connector 68, a unitary connector 72, a transitional zone 112, or cylinders 76A, 76B or 76C, and so on, rather than that shown in the examples shown. Further, threaded screws, extensions 74A, 74B, 74C, or non-threaded means of securing the variations to implant 22A or implant 22B, may be interchanged from one flexible abutment variation to another, and are not to be construed as limitative. All elements may be switched into different combinations than those shown in the figures.

All implementations of the flexible abutments are customizable for a given site fit, either during manufacture, or after manufacture. During manufacture includes dimensional planning based on scanning or CT data, or on physical impressions and models. Customizations performed after initial manufacture includes relying on flexing of the flexible materials to automatically fit into spaces into which they are seated, material removal or addition by the clinician, rendering a moldable flexible abutment to be non-moldable after secured to implant 22A or implant 22B, and so on.

In some implementations, an implant and flexible abutment are inserted into an osteotomy with significantly devoid of periodontal ligament PDL fibers. In some implementations, a portion of PDL fibers remain with the osteotomy. As such, some PDL fibers remain in their original location, and some comprise segments of fibers moved to other locations in the osteotomy. In some implementations, an implant and flexible abutment are inserted into a tooth socket where the PDL fibers have substantially remained in their original natural locations, or are substantially intact, such as when implants are connectable to the PDL via means under current and future research. Such insertion of an implant and flexible abutment into a socket having an intact PDL would likely incur substantially vertical movements, in lieu of rotational movements.

In accordance with another aspect, there is provided a method for securing a prosthesis to an implant comprising the steps of: inserting said implant into an osseous structure, securing a substantially flexible healing abutment to said implant, waiting a time period for healing to progress, removing said substantially flexible healing abutment from said implant, and securing said prosthesis to said implant.

In accordance with another aspect, there is provided a method for managing the osseointegration of implant 22A comprising the steps of: placing implant 22A into osteotomy 26, securing soft tooth 20 to implant 22A, wherein soft tooth 20 contacts gingiva 28, and wherein soft tooth 20 substantially mimics the appearance of a natural tooth, such that ambient forces against soft tooth 20 readily deform soft tooth 20, and are absorbed by soft tooth 20, such that forces subsequently transferred to implant 22A are reduced during the osseointegration time period, removing soft tooth 20, and securing a prosthesis to implant 22A.

In some implementations, a soft tooth 20 is fabricated from digital data acquired from a CT or other imaging. In some implementations, a soft tooth 20 is selected from stock sizes, shapes, and shades. Implant 22A is placed such that the rotation of internal hex 42 is known. The implant 22A stability is assessed to be compatible with the use of soft tooth 20 during the healing phase.

External hex 40 is rotated to align with the known rotation of internal hex 42, and seated therein. Connector 38 seats into platform 32A. A drive tool is inserted into access hole 34A, engages screw 36, and secures screw 36 into screw hole 44.

As soft tooth 20 is seated onto platform 32A, the shape of soft tooth 20 interferes somewhat with adjacent structures. Soft tooth 20 readily deforms to permit proper seating despite slight interferences. Further, lateral interferences of tooth 24 with the mesial or distal interproximal surfaces of adjacent teeth lack sufficient force to cause inadvertent movement or repositioning of the adjacent teeth. Yet further, the dental arches are occludable despite a possible slight interferences that might be present with tooth 24, although it is preferred that tooth 24 is configured to avoid occlusal interferences.

The drive tool is removed from access hole 34A. Soft tooth 20 is thereby anti-rotationally positioned, and properly seated and secured to implant 22A, as shown in FIG. 1A. Secured soft tooth 20 mimics the appearance of a tooth. Gingiva 28 is secured against soft tooth 20, such that soft tooth 20 is able to control the emergence profile of healing gingiva 28.

During the osseointegration time period, ambient forces impinging upon soft tooth 20 cause substantial deformation of tooth 24. Forces subsequently transferred from tooth 24 to implant 22A via connector 38 are substantially reduced relative to the causative ambient force. As such, chances are improved that implant 22A will successfully osseointegrate during the healing period without substantial disruption due to ambient forces impinging on soft tooth 20.

After an appropriate healing period for osseointegration and gingiva 28 emergence profile, the clinician inserts a drive tool into access hole 34A, and rotationally removes screw 36. Connector 38 is remains seated fully into platform 32A.

A threaded stability assessment pin is inserted into access hole 34A, and pushed through the screw hole of connector 38, and then secured into screw hole 44. The stability assessment pin is securely seated against connector 38, and connector 38 is thereby secured to platform 32A. The implant osseointegration stability is read by a stability assessment device. If osseointegration is found to be satisfactory, then the stability assessment pin is removed from screw hole 44, connector 38, and access hole 34A. Screw 36 is replaced through access hole 34A, and resecured into screw hole 44.

A prosthesis is fabricated. Prosthesis fabrication may employ insertion of a scan body or impression coping into access hole 34A without removal of soft tooth 20 from platform 32A, digital data, or other means of modeling. After a prosthesis is fabricated, screw 36 is loosened from screw hole 44, and soft tooth 20 is removed from implant 22A. The prosthesis is secured to implant 22A.

In some implementations, a shell tooth abutment 54 is selected from stock sizes and shades, or fabricated from digital data, such that shell tooth abutment 54 will adequately mimic a tooth. Implant 22A is placed so that the rotation of internal hex 42 is known. The initial stability of implant 22A is assessed to confirm healing abutment compatibility.

The clinician adjusts shell abutment 56 as needed to fit with potentially interfering adjacent oral structures, and to fit with gingiva 28 to optimize healing thereof, and to minimize ambient forces that might impinge on shell abutment 56. External hex 40 is rotated to align with the known rotation of internal hex 42, and is seated therein, thereby seating connector 38 into platform 32A, as shown in FIG. 1C.

The clinician determines that shell abutment 56 has a color mismatch with the adjacent teeth. Bulk 50B is detached from shell abutment 56, and a differently colored bulk 50B is attached to shell abutment 56, such as by flexibly locking into undercuts, or other attachment means.

A drive tool is inserted into access hole 34B, engages screw 36, secures screw 36 into screw hole 44, and is removed from access hole 34B. Shell tooth abutment 54 is thereby anti-rotationally positioned and secured to implant 22A, as shown in FIG. 1C. Shell tooth abutment 54 substantially mimics the appearance of a tooth.

Gingiva 28 is secured against shell tooth abutment 54, such that shell tooth abutment 54 is able to control the emergence profile of healing gingiva 28. Secured shell tooth abutment 54 mimics the appearance of a tooth. After a partial healing period, shell abutment 56 is further adjustable by the clinician after shrinkage of healing gingiva 28.

During the osseointegration time period, even slight to moderate ambient forces impinging upon shell tooth abutment 54 are able to cause substantial deformation of bulk 50B, and deformation or flexing of shell abutment 56. Shell tooth abutment 54 and bulk 50B deform readily under force loading. Forces subsequently transferred from bulk 50B and shell abutment 56 to implant 22A via connector 38 are substantially reduced relative to the causative ambient force. As such, chances are improved that implant 22A will successfully osseointegrate during the healing period without substantial disruption due to ambient forces impinging on shell tooth abutment 54.

After an appropriate healing period for osseointegration and gingiva 28 emergence profile, bulk 50B is detached to expose scanning features 52. Scanning features 52, and healed gingiva 28, and other adjacent structures, are scanned for prostheses fabrication. Bulk 50B is reattached. A prosthesis is fabricated. Screw 36 is loosened from screw hole 44, and shell tooth abutment 54 is removed from implant 22A. The prosthesis is secured to implant 22A.

In accordance with another aspect, there is provided a method for managing the osseointegration of implant 22A comprising the steps of: placing implant 22A into osteotomy 26, securing shell tooth abutment 54 to implant 22A, wherein soft tooth 20 contacts gingiva 28, and wherein shell tooth abutment 54 substantially mimics the appearance of a natural tooth, such that ambient forces against shell tooth abutment 54 readily deform shell tooth abutment 54, and are absorbed by shell tooth abutment 54, such that forces subsequently transferred to implant 22A are reduced during the osseointegration time period, leaving shell tooth abutment 54 secured to implant 22A as the prosthesis.

In some implementations, when shell tooth abutment 54 is serving as a prosthesis, such as when bone support for an implant is compromised, bulk 50B may be removably detachable from connector 38 to provide access to screw 36, such as via undercuts in shell abutment 56, or other connection means. In some implementations, access hole 34B would be absent.

In accordance with another aspect, there is provided a method for managing the osseointegration of implant 22A comprising the steps of: placing implant 22A into osteotomy 26, securing short shell abutment 62A to implant 22A, wherein short shell abutment 62A contacts gingiva 28, such that ambient forces against short shell abutment 62A readily deform short shell abutment 62A, and are absorbed by short shell abutment 62A, such that forces subsequently transferred to implant 22A are substantially reduced during the osseointegration time period, scanning a scan body while connected to short shell abutment 62A, removing short shell abutment 62A, and securing a prosthesis to implant 22A.

In some implementations, a short shell abutment 62A is fabricated from digital data acquired from a CT and other imaging, such that short shell 64A has a custom configuration for controlling gingiva 28 emergence profile, and a scanning connector 68 connects short shell abutment 62A to implant 22A.

An implant 22A is placed so that the rotation of internal hex 42 is known, and the stability of implant 22A is assessed to be adequate. External hex 40 is rotated to align with internal hex 42, and inserted into internal hex 42, as scanning connector 68 is inserted into platform 32A.

The external surface of scanning connector 68 has a thin, elastomeric anti-bacterial coating. The coating does not interfere with proper seating of scanning connector 68, but engages the internal surface of platform 32A to the degree that bacteria and debris are physically and chemically inhibited from entering the interstitial space therebetween.

A drive tool is inserted into access hole 34D, engages screw 36, and secures screw 36 into screw hole 44. Scanning connector 68 is thereby anti-rotationally seated and secured to platform 32A, as shown in FIG. 2A.

During the osseointegration time period, ambient forces impinging upon soft filler 66A and flexible short shell 64A cause substantial deformation of short shell abutment 62A, thereby significantly reducing forces transferred to implant 22A. The clinician is able to adjust the shape of short shell 64A, or soft filler 66A, such as needed to optimize the healing of gingiva 28, and to minimize ambient forces impinging on short shell abutment 62A.

After an appropriate healing period for osseointegration and gingiva 28 emergence profile, the clinician inserts a drive tool into access hole 34D, and removes screw 36. Scanning connector 68 remains seated fully into platform 32A. The elastomeric coating on the surface of scanning connector 68 enhances the stability of scanning connector 68 to remain securely seated in platform 32A when screw 36 has been removed.

A scan body is inserted into access hole 34D, and anti-rotationally keyed into scanning hex 70. A scan body screw is inserted through access hole 34D, and secured into screw hole 44, thereby securing the scan body to short shell abutment 62A. The scan body, shell abutment 64A, gingiva 28, and relevant adjacent structures, are scanned. The scan body is removed from short shell abutment 62A, and screw 36 is replaced to secure short shell abutment 62A to implant 22A.

A prosthesis is fabricated. After a prosthesis is fabricated, screw 36 is removed, and short shell abutment 64A is removed from implant 22A. The emergence profile of gingiva 28 conforms to the custom configuration of short shell 64A and to the subsequent shape of the prosthesis. The prosthesis is secured to implant 22A.

In some implementations, a drive tool is inserted into access hole 34G of flexible cap 80B, and engages drive socket 78A. Flexible cap 80B is thereby securely carried on the drive tool to an implant 22A that has been implanted deeply into osteotomy 26. Cylinder 76A is nested into internal hex 42, and extension 74A is rotated into screw hole 44.

As flexible cap 80B is rotated and seated into implant 22A, soft cap 82B interferes with bony margin 30, and with platform 32A. Soft cap 82B readily deforms from the pressure caused by the interference with bony margin 30 and platform 32A. As such, significant premature resistance to the insertion and securing of flexible cap 80B to platform 32A is avoided, and does not occur. Therefore, unitary connector 72 is properly seated into platform 32A, and extension 74A is properly secured into screw hole 44, as shown in FIG. 3B.

During the osseointegration time period, ambient forces impinging upon soft cap 82B cause substantial deformation thereof, thereby reducing forces transferred to implant 22A. As such, chances are improved that implant 22A will successfully osseointegrate during the healing period without substantial disruption due to ambient forces impinging on flexible cap 80B.

After an appropriate healing period for osseointegration, and for the gingiva 28 emergence profile, flexible cap 80B is removed from platform 32A, and an impression coping is connected to platform 32A while impressions are made. Flexible cap 80B is resecured to platform 32A while a prosthesis is fabricated. After a prosthesis is fabricated, flexible cap 80B is removed from implant 22A, and the prosthesis is secured to implant 22A.

In accordance with another aspect, there is provided a method for managing the osseointegration of implant 22A comprising the steps of: placing an implant 22A into osteotomy 26, securing an expandable healing cap 84 to implant 22A, covering expandable healing cap 84 with gingiva 28, waiting for osseointegration, causing expandable healing cap 84 to expand to form an expanded expandable healing cap 84, permitting covering gingiva 28 to thereby slough off to expose expanded expandable healing cap 84, making a prosthesis, removing expanded expandable healing cap 84 from implant 22A, and securing a prosthesis to implant 22A.

An implant 22A is found to have low initial stability at placement. An expandable healing cap 84 is selected, such that the height and volume of expandable body 86 is sufficiently small to permit closure of gingiva 28 over expandable healing cap 84.

A drive tool is inserted into access hole 34H to engage drive socket 78A. Cylinder 76A of unitary connector 72 is seated into internal hex 42, and extension 74A is rotationally secured into screw hole 44. As such, expandable healing cap 84 is secured to platform 32A.

Gingiva 28 is secured over the top of, and entirely covers, expandable healing cap 84, as shown in FIG. 4A. The gingiva 28 covering over expandable healing cap 84 provides additional protection from forces relative to exposed healing abutments. Gingiva 28 is tattooed to indicate the center of expandable body 86 under gingiva 28.

In one implementation, after an osseointegration time period, a syringe is loaded with 0.5 cc sterile water. The needle of the syringe is aligned with the tattoo mark on gingiva 28, and inserted through gingiva 28 that covers expandable healing cap 84. The needle penetrates through top surface 92, and into internal volume 90.

Liquid dye is aspirated from inside internal volume 90 and into the syringe to confirm that the needle tip is inside internal volume 90. Sterile water is forcefully injected into Internal volume 90, thereby pressurizing Internal volume 90. Such pressurization causes stretching and enlargement of the exterior surface of expandable body 86, such that top surface 92 moves away from unitary connector 72, and presses forcefully against gingiva 28 covering expandable body 86.

Sterile water continues to be injected into internal volume 90 until gingiva 28 substantially blanches, and bulges upward, or until injection of a volume of water precalculated relative to the gingiva 28 thickness, thereby forming expanded expandable body 86.

The expansion of expandable body 86 causes surface features 94 to reangle from a relatively horizontal orientation to a more vertical orientation, thereby deploying surface features 94. The somewhat sharp edges of deployed surface features 94 press against, and tend to cut through, gingiva 28.

After a healing time period, pressure against gingiva 28 exerted by expanded expandable body 86, and by surface features 94, causes gingiva 28 to slough away from the area above expanded expandable body 86. As such, expanded expandable body 86 becomes exposed to the oral cavity, and protrudes above the surface of gingiva 28, as shown in FIG. 4B.

Expanded expandable body 86 also reconfigures in shape while expanded, such that gingiva 28 heals to a desirable shape and emergence profile. As such, expanded expandable healing cap 84 is readily accessible for removal, without requiring a second-stage surgery exposure.

After healing of gingiva 28, expanded expandable healing cap 84 is removed from platform 32A, and a scan body is connected to platform 32A during scanning. Expanded expandable healing cap 84 is resecured to platform 32A while a prosthesis is fabricated. A prosthesis is fabricated. Expanded expandable healing cap 84 is removed from platform 32A, and a prosthesis is secured to platform 32A.

In accordance with another aspect, there is provided a method for managing the osseointegration of implant 22B comprising the steps of: placing an implant 22B into osteotomy 26, securing a monolithic flexible cap 96B to implant 22B by engaging tabs 102 into undercuts of undercut hex 100, waiting for osseointegration, making a prosthesis, removing monolithic flexible cap 96B from implant 22B at least by releasing tabs 102 from undercut hex 100, and securing a prosthesis to implant 22B.

In some implementations, an implant 22B is inserted into osteotomy 26. A monolithic flexible cap 96B is selected from stock sizes. An insertion tool is inserted into access hole 34J, thereby securely holding monolithic flexible cap 96B on the insertion tool, and monolithic flexible cap 96B is carried to implant 22B.

Extension 74C is guided into the orifice of screw hole 44. The insertion tool is pushed against the floor of hole undercut 104, thereby pushing monolithic flexible cap 96B toward platform 32B, and sliding extension 74C partly into screw hole 44. Extension 74C therefore contacts the threads of screw hole 44 with a degree of friction, but such frictional contact does not prevent the sliding insertion thereof.

As the insertion tool forcefully pushes monolithic flexible cap 96B further toward platform 32B, first, tabs 102 contact the upper rim of undercut hex 100, second, tabs 102 are compressed by forceful contact with the flanks of undercut hex 100, thereby permitting monolithic flexible cap 96B to advance yet further, third, compressed tabs 102 slide downward along the flanks of undercut hex 100 toward the bottom surface of platform 32B, and fourth, tabs 102 decompress to rebound into the open undercut area of undercut hex 100 as monolithic flexible cap 96B seats fully into platform 32B, as shown in FIG. 5B. Once tabs 102 are properly decompressed into mating undercuts of undercut hex 100, then monolithic flexible cap 96B is properly secured to platform 32B. In some implementations, rotation of monolithic flexible cap 96B and of tabs 102 facilitates proper decompression and mating thereof into undercuts of undercut hex 100, such as by correspondingly rotating the insertion tool therefore.

In some implementations, there is provided a method for securing a substantially tooth-shaped soft prosthesis to an implant comprising the steps of: inserting an implant into an osseous structure, securing a soft prosthesis to the implant, wherein at least the greater portion of the soft prosthesis is substantially elastomeric, wherein forces brought against the soft prosthesis can substantially and readily deform the soft prosthesis, thereby substantially reducing forces subsequently transferred from the soft prosthesis to the implant, and from the implant to the osseous structure.

In some implementations, a tooth-shaped soft prosthesis may be removably detachable by a clinician or by a patient, such as to a platform 32B. In some implementations, a soft prosthesis may comprise a soft tooth-shaped body that is analogous to abutment 56 of FIG. 1C, and a connector comprising a cylinder 76C with tabs 102. As such, the soft prosthesis is removably detachable from a platform, such as 32B. In some implementations, no access hole is provided through the soft body for use in connecting or detaching the soft prosthesis.

The above combination of a soft body with a removably detachable connector is not to be construed as limitative, but only illustrative, as many other combinations of a soft prosthesis having a removable detachment means from an implant are usable. Such a soft prosthesis may be used when supporting bone is unusually compromised, or when a patient needs to delay a traditional prosthesis due to personal constraints.

In some implementations, there is provided a method for placing an implant into an osseous structure comprising the steps of: inserting an implant into an osseous structure, wherein the implant comprises an implant portion and an integral flexible prosthesis portion, such that forces brought against the prosthesis portion substantially and readily deform the prosthesis portion, thereby substantially reducing forces subsequently transferred from the soft prosthesis portion to the implant portion, and from the implant portion to the osseous structure.

In some implementations, stratified abutment implant 106 is selected for insertion into an osteotomy 26. An implant driver is inserted into the orifice of access hole 34K. The incisal edge of prosthetic abutment 108 is flexed facially to permit a straight-line path of insertion for the implant driver until engaged into internal drive 110. Implant 22C is partly inserted into osteotomy 26 until resistance to insertion is encountered.

The implant driver rotates stratified abutment implant 106 to advance further into osteotomy 26. Prosthetic abutment 108 and implant 22C rotate together as a combined, integrated unit. During rotations, portions of prosthetic abutment 108 interfere with adjacent teeth, or with bony margin 30. Prosthetic abutment 108 thereby flexes readily to permit substantially unimpeded rotation of stratified abutment implant 106 until fully inserted into osteotomy 26, as shown in FIG. 6. The rotation of stratified abutment implant 106 is adjusted to ensure proper alignment and interproximal contact with adjacent teeth and structures. Both during and after healing of gingiva 28 and osseointegration of osteotomy 26, ambient forces readily deform prosthetic abutment 108, and thereby substantially reduce forces subsequently transferred to implant 22C, and to osteotomy 26.

The term osteotomy is not to be construed as limitative. For example, a fractured tooth may be extracted from a tooth socket where the native periodontal ligament remains intact, and a coated implant having a customized configuration may be implanted into the socket, rather than into an osteotomy. A suitable coating may comprise a type of hydroxyapatite, a cementum-derived material, or other bioavailable coatings conducive to ligament fiber attachment. A flexible abutment may be secured to the implant during a healing period where periodontal ligament fibers attach to the implant. A flexible abutment may also facilitate initial implant stabilization by engaging adjacent structures, or may facilitate limiting bacteria.

1. A substantially flexible abutment for use in combination with an implant that is implanted into an osseous structure, wherein said abutment is configured to occupy a given volume of space over said implant, and wherein the greater portion of said abutment is substantially elastomeric, such that forces brought against said abutment tend to substantially and readily deform said abutment, thereby substantially reducing forces subsequently transferred to said osseous structure.

2. The abutment of claim 1, wherein the configuration of said abutment substantially resembles a tooth.

3. The abutment of claim 2, wherein the configuration of said abutment substantially resembles a tooth at least in the portion that contacts gingiva.

4. The abutment of claim 1, wherein said abutment is substantially symmetrical.

5. The abutment of claim 1, wherein said abutment is substantially expandable.

6. The abutment of claim 1, wherein said abutment is detachably connectable to said implant.

7. The abutment of claim 1, wherein said abutment is substantially integral with said implant.

8. A method for securing a prosthesis to an implant comprising the steps of: inserting said implant into an osseous structure, securing a substantially flexible abutment to said implant, wherein said abutment is configured to occupy a given volume of space over said implant, and wherein the greater portion of said abutment is substantially elastomeric, waiting a time period for healing to progress, such that forces brought against said abutment during said time period tend to substantially and readily deform said abutment, thereby substantially reducing forces subsequently transferred to said osseous structure, removing said abutment from said implant, and securing said prosthesis to said implant.

9. The method of claim 8, wherein the configuration of said abutment substantially resembles a tooth.

10. The method of claim 8, wherein the configuration of said abutment substantially resembles a tooth at least in the portion that contacts gingiva.

11. The method of claim 8, wherein said abutment is substantially symmetrical.

12. The method of claim 8, wherein said abutment is expanded prior to removing from said implant.

13. A method for implanting an implant into an osseous structure comprising the steps of: implanting said implant into an osseous structure, wherein said implant is secured to a flexible prosthesis, and wherein at least the greater portion of said prosthesis is substantially elastomeric, such that forces brought against said prosthesis tend to substantially and readily deform said prosthesis, thereby substantially reducing forces subsequently transferred from said prosthesis to said osseous structure.

14. The method of claim 13, wherein said prosthesis is secured to said implant prior to implanting said implant into said osseous structure.

15. The method of claim 13, wherein said prosthesis is secured to said implant immediately after implanting said implant into said osseous structure.

16. The method of claim 13, wherein said prosthesis is secured to said implant only after a given degree of osseointegration has occurred.
